(19) United States
(12) Patent Application Publication
(10) Pub. No.: US 2012/0082855 A1
(43) Pub. Date: Apr. 5, 2012

(54) Optical film, polarizing plate, image display device, and method for manufacturing optical film

(75) Inventors: Jyunko Ohta, Kanagawa (JP); Takato Suzuki, Kanagawa (JP)

(73) Assignee: FUJIFILM Corporation, Tokyo (JP)

(21) Appl. No.: 13/200,710

(22) Filed: Sep. 29, 2011

(30) Foreign Application Priority Data
Sep. 30, 2010 (JP) 2010-223287
Sep. 16, 2011 (JP) 2011-203842

(51) Int. Cl. B32B 27/06; B05D 5/06

(52) U.S. Cl. 428/423.1; 427/164

(57) ABSTRACT

An optical film contains a transparent base material having thereon a hard coat layer formed of a hard coat layer forming composition containing the specific components, wherein a refractive index of the hard coat layer is 1.45 or more and not more than 1.55; and in the hard coat layer forming composition, a content of the component (a) is a content of the component (b) or more.

### BACKGROUND OF THE INVENTION

1. Field of the Invention

The present invention relates to an optical film, a polarizing plate, an image display device, and a method for manufacturing an optical film.

2. Description of the Related Art

In image display devices such as a cathode ray tube display device (CRT), a plasma display (PDP), an electroluminescence display (ELD), a vacuum fluorescent display (VFD), a field emission display (FED), and a liquid display device (LCD), in order to prevent scuffing on the display surface from occurring, it is suitable to provide a hard coat film having a hard coat layer on a transparent base material.

Also, in the case of image display devices with high definition and high grade as in recent LCDs, in addition to the foregoing prevention of scuffing onto the display surface, for the purpose of preventing lowering of contrast to be caused due to reflection of external light on the display surface or glaring of an image, it is also performed to provide an antireflection layer or an optical film having an antireflection layer on a hard coat layer.

In such a hard coat layer-provided optical film, there may be the case where an interference fringe is caused due to an interference by an interface between the transparent base material and the hard coat layer and reflected light from the surface of the hard coat layer, and furthermore, tinted interference unevenness is generated. The interference unevenness impairs visibility or image quality of a display image of the image display device, and therefore, its improvements are required.

As a method of improving the interference unevenness, for example, JP-A-2007-293324 (the term “JP-A” as used herein means an “unexamined published Japanese patent application”) describes that the interference unevenness can be prevented from occurring by forming a hard coat layer by using a composition containing a solvent having permeability to a base material, a polyfunctional acrylate monomer and a polyfunctional urethane acrylate monomer, thereby making an interface between the base material and the hard coat layer disappear.

Also, though JP-A-2009-263600 and JP-A-2010-143213 do not describe the interference unevenness, these patent documents describe a hard coat layer forming composition containing a polyfunctional acrylate monomer, a urethane acrylate monomer and ethyl acetate or butyl acetate as a solvent.

Also, though JP-A-2009-186760 does not describe the interference unevenness, this patent document describes a hard coat layer forming composition containing two kinds of monomers of pentaerythritol tetraacrylate and hydroxyethyl methacrylate, zirconium oxide and ethyl acetate or acetone as a solvent.

### SUMMARY OF THE INVENTION

Even in the technique described in JP-A-2007-293324, the interference unevenness generated by interfacial reflection between the transparent base material and the hard coat layer is suppressed to some extent. However, in recent image display devices, requirements of a high contrast ratio and a high-grade image with denseness of black color are increasing. Also, the interference unevenness is easily emphasized under a three-wavelength light source, and in response to this, suppression of the interference unevenness on a higher level is required.

The interfacial reflection which causes the interference unevenness is easy to occur in the case where a difference in refractive index between a transparent base material and a hard coat layer is large, and a distinct interface is present therebetween. It may be assumed that the hard coat layer described in JP-A-2009-186760, which is obtained by curing a composition containing pentaerythritol tetraacrylate, hydroxyethyl methacrylate and zirconium oxide (refractive index: about 2.20), contains zirconium oxide, its refractive index is high (refractive index: about 1.62), and hence, suppression of the interference unevenness is not sufficient.

Also, as a result of investigations made by the present inventors, it was noted that depending upon a degree of dissolution in the base material or permeation into the base material of a solvent having solubility or a solvent having permeability against the base material described in JP-A-2007-293324, there may be the case where the hard coat layer side of the transparent base material strongly receives shrinkage following curing at the time of forming a hard coat layer, thereby causing curl, or there may be the case where the interface between the base material and the hard coat layer does not disappear, so that the interfacial reflection is not effectively suppressed.

An object of the invention is to provide an optical film in which interference unevenness is suppressed, a sufficient hardness is presented, and furthermore, curl is suppressed.

Another object of the invention is to provide a method for manufacturing the subject optical film, a polarizing plate using the subject optical film as a protective film for polarizing plate, and an image display device having the subject optical film or polarizing plate.

In order to solve the foregoing problems, the present inventors made extensive and intensive investigations. As a result, it has been noted that when a solvent having dissolving ability and swelling ability against a base material is used as a solvent to be used for a hard coat layer forming composition, the base material and monomers are effectively mixed with each other due to permeation of the monomers into the base material by swelling of the base material and dissolution of the base material itself, gradient of refractive index change at refractive index interface between the base material and the hard coat layer becomes lower (namely, interface disappears), whereby interference unevenness can be greatly suppressed as compared with the related art. Also, it has been noted that when monomers having good affinity with the base material (SP values are close to each other) and having a low molecular weight are used, permeation of the monomers into the base material proceeds, so that mixing of the base material and the hard coat layer is effectively achieved; and that when low-molecular weight monomers having a small number of functional groups are used, curl can be suppressed.

Also, when two kinds of trifunctional or more functional monomers having good affinity with the base material (SP values are close to each other) and having a different mass average molecular weight from each other within the range of more than 40 and less than 1600 are used, there are obtained different two kinds of monomer distributions which do not smoothly change in the film thickness direction due to a difference of permeability into the base material between the two kinds of monomers. However, it has been noted that since the affinity of the two kinds of monomers with the base material is good, and the both are easily mixed with each other, the distribution of the monomers and the base material smoothly changes in terms of a total of the film (namely, the refractive index continuously changes in the film thickness direction), and so to speak, a gradation layer in which the refractive index continuously changes is formed, whereby the interference unevenness can be suppressed (here, this means that each of the two kinds of monomer distributions may smoothly change in the film thickness direction; however, in the case of using only a single kind of monomer, a region where the refractive index steeply changes somewhere of the base material, the gradation layer, or the hard coat layer is frequently formed; and even when the single kind of monomer distribution slightly has bending in this way, the other kind of monomer having a different degree of permeation into the base material is present, whereby the monomer distribution becomes smooth in the film thickness direction as the whole of the base material, the gradation layer, and the hard coat layer).

Furthermore, when trifunctional or more functional monomers are used, a hard coat layer having a high hardness is obtained.

That is, the foregoing objects of the invention can be achieved by the following means.

(1) An optical film comprising a transparent base material having thereon a hard coat layer formed of a hard coat layer forming composition containing the following (a), (b), (c) and (d),

wherein

a refractive index of the hard coat layer is 1.45 or more and not more than 1.55; and

in the hard coat layer forming composition, a content of the component (a) is a content of the component (b) or more:

(a) a compound having three or more functional groups in one molecule thereof and having an SP value SPₐ according to the Hoy method satisfying a relation of 19<SPₐ<25 and a mass average molecular weight Mwₐ satisfying a relation of 40<Mwₐ<1,600;

(b) a urethane compound having three or more functional groups in one molecule thereof and having an SP value SP_{b} according to the Hoy method satisfying a relation of 19<SP_{b}<25 and a mass average molecular weight Mw_{b} satisfying a relation of 150≧|Mw_{b}−Mwₐ|≦500;

(c) a solvent having dissolving ability against the transparent base material; and

(d) a solvent having swelling ability against the transparent base material.

(2) The optical film according to (1) above, wherein the solvent (c) is at least one member of methyl acetate and acetone.
(3) The optical film according to (1) or (2) above, wherein the solvent (d) is methyl ethyl ketone.
(4) The optical film according to any one of (1) to (3) above, wherein a content of the solvent (c) is a content of the solvent (d) or more.
(5) The optical film according to any one of (1) to (4) above, wherein the SP value SPₐ of the compound (a) satisfies a relation of 21<SPₐ<25.
(6) The optical film according to any one of (1) to (5) above, wherein the transparent base material is a cellulose acylate film.
(7) The optical film according to any one of (1) to (6) above, wherein a haze of the hard coat layer is not more than 1%.
(8) An optical film comprising a transparent base material having thereon a hard coat layer having a haze of not more than 1.0%, wherein a peak intensity PV value obtained by subjecting a reflectance spectrum by an optical interference method to a Fourier transform is from 0.000 to 0.006.
(9) The optical film according to (8) above, wherein the PV value is from 0.000 to 0.003.
(10) A polarizing plate comprising the optical film according to any one of (1) to (9) above as a protective film for polarizing plate.
(11) An image display device comprising the optical film according to any one of (1) to (9) above or the polarizing plate according to (10) above.
(12) A method for manufacturing the optical film according to any one of (1) to (7) above, which comprises a step of coating the hard coat layer forming composition on the transparent base material and curing it to form a hard coat layer.

According to the invention, it is possible to provide a hard coat layer forming composition capable of forming a hard coat layer in which interference unevenness is suppressed, a sufficient hardness is presented, and furthermore, curl of a film can be suppressed, on a transparent base material.

Also, according to the invention, it is possible to provide an optical film in which interference unevenness is suppressed, a sufficient hardness is presented, and curl is suppressed.

### BRIEF DESCRIPTION OF THE DRAWINGS

FIG. 1 is a view explaining light interference of a thin film.

FIG. 2 is one example of a reflectance spectrum of a thin film obtained by a light interference method.

FIG. 3 is a view showing an example of measuring a curl of an optical film according to the method of ANSI/ASC PH1.29-1985, Method A.

### DESCRIPTION OF REFERENCE NUMERALS AND SIGNS

1 denotes Optical film and 2 denotes Curl plate.

### DETAILED DESCRIPTION OF THE INVENTION

Modes for carrying out the invention are hereunder described in detail, but it should not be construed that the invention is limited thereto. Incidentally, in this specification, in the case where a numerical value represents a physical property value, a characteristic value, etc., the terms “from (numerical value 1) to (numerical value 2)” mean “(numerical value 1) or more and not more than (numerical value 2)”. Also, in this specification, the term “(meth)acrylate” means “at least one of acrylate and methacrylate”. The same is also applicable to the terms “(meth)acrylic acid” and “(meth)acryloyl” or the like.

Incidentally, in the invention, the “repeating unit corresponding to a monomer” and the “repeating unit derived from a monomer” mean that a component obtained after polymerization of the monomer becomes a repeating unit.

### [Optical Film]

An embodiment of the optical film of the invention is concerned with an optical film comprising a transparent base material having thereon a hard coat layer formed of a hard coat layer forming composition containing the following (a), (b), (c) and (d),

wherein

a refractive index of the hard coat layer is 1.45 or more and not more than 1.55; and

in the hard coat layer forming composition, a content of the component (a) is a content of the component (b) or more:

(a) a compound having three or more functional groups in one molecule thereof and having an SP value SPₐ according to the Hoy method satisfying a relation of 19<SPₐ<25 and a mass average molecular weight Mwₐ satisfying a relation of 40<Mwₐ<1,600;

(b) a urethane compound having three or more functional groups in one molecule thereof and having an SP value SP_{b} according to the Hoy method satisfying a relation of 19<SP_{b}<25 and a mass average molecular weight Mw_{b} satisfying a relation of 150≦|Mw_{b}−Mwₐ|≦500;

(c) a solvent having dissolving ability against the transparent base material; and

(d) a solvent having swelling ability against the transparent base material.

When the hard coat layer is formed on the transparent base material by using the hard coat layer forming composition having the foregoing constitution, interfacial reflection between the transparent base material and the hard coat layer is suppressed, and interference unevenness can be suppressed. In particular, in the case of using a cellulose ester film (especially, a cellulose acetate film) as the transparent base material, an effect for suppressing the interference unevenness is large. As for a reason for this, it may be assumed that the following mechanism serves. That is, following the matter that the solvent (d) swells the cellulose ester film, the compounds (a) and (b) permeate into the cellulose ester film. Also, in view of the matter that the solvent (c) dissolves the cellulose ester film therein, the cellulose ester diffuses into the hard coat layer side. Here, since the compounds (a) and (b) are different in a degree of permeation into the transparent base material from each other, a region where the compound distribution gradually changes from the cellulose ester film side toward the hard coat layer side (this region will be hereinafter referred to as “gradation region” or “gradation layer”) is formed between the cellulose ester film and the hard coat layer. For that reason, a change of refractive index between the cellulose ester film and the hard coat layer becomes very gentle (the interface disappears), interfacial reflection is suppressed, and interference unevenness is suppressed. Incidentally, in the compound distribution extending from the hard coat layer to a support, a distribution amount is not always required to change in a fixed proportion, and so far as the distribution smoothly changes in the interface portion, the interference unevenness is suppressed.

First of all, the hard coat layer forming composition is hereunder described in detail.

### [(a) Compound Having Three or More Functional Groups in One Molecule Thereof]

The component (a) which is contained in the hard coat layer forming composition according to the invention is described.

The component (a) which is used in the invention is a compound having three or more functional groups in one molecule thereof and having an SP value SPₐ according to the by method satisfying a relation of 19<SPₐ<25 and a mass average molecular weight Mwₐ satisfying a relation of 40<Mwₐ<1,600.

The compound having three or more functional groups in one molecule thereof as in the component (a) can function as a binder and a curing agent of the hard coat layer and makes it possible to enhance the strength or resistance to scuffing of coating film.

A number of functional groups in one molecule in the component (a) is preferably from 3 to 20, more preferably from 3 to 10, still more preferably from 3 to 5, and yet still more preferably 3 or 4.

Examples of the component (a) include compounds having a polymerizable functional group (polymerizable unsaturated double bond) such as a (meth)acryloyl group, a vinyl group, a styryl group, and an allyl group. Above all, compounds having a (meth)acryloyl group or —C(O)OCH═CH₂ are preferable. In particular, the following compounds containing three of more (meth)acryloyl groups in one molecule thereof can be preferably used.

As specific examples of the compound having a polymerizable functional group, there can be exemplified (meth)acrylic acid diesters of an alkylene glycol, (meth)acrylic acid diesters of a polyoxyalkylene glycol, (meth)acrylic acid diesters of a polyhydric alcohol, (meth)acrylic acid diesters of an ethylene oxide or propylene oxide adduct, epoxy (meth)acrylates, urethane (meth)acrylates, and polyester (meth)acrylates.

Above all, esters of a polyhydric alcohol and (meth)acrylic acid are preferable. Examples thereof include pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethyloethane tri(meth)acrylate, ditrimethylopropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, urethane acrylate, polyester polyacryl ate, and caprolactone-modified tris(acryloyloxyethyl)isocyanurate.

The mass average molecular weight Mwₐ of the component (a) satisfies a relation of 40<Mwₐ<1,600. From the viewpoints of suppressing the interference unevenness due to the formation of a gradation region and enhancing the hardness of the hard coat layer, a relation of 100<Mwₐ<1,600 is preferable, and a relation of 200<Mwₐ<1,600 is more preferable.

Incidentally, the mass average molecular weight is a mass average molecular weight as reduced into polystyrene, which is measured by means of gel permeation chromatography.

The SP value SPₐ of the component (a) according to the Hoy method satisfies a relation of 19<SPₐ<25. From the viewpoint of suppressing the interference unevenness due to the formation of a gradation region, a relation of 19.5<SPₐ<24.5 is preferable, and a relation of 20<SPₐ<24 is more preferable.

Incidentally, the SP value (solubility parameter) in the invention is a value calculated according to the Hoy method, and the Hoy method is described in POLYMER HANDBOOK FOURTH EDITION.

A ratio of the mass average molecular weight Mwₐ and the number of functional groups in one molecule of the component (a) satisfies preferably a relation of 70<(Mwₐ/(number of functional groups in one molecule))<300, more preferably a relation of 70<(Mwₐ/(number of functional groups in one molecule))<290, and still more preferably a relation of 70<(Mwₐ/(number of functional groups in one molecule))<280. When the ratio of the mass average molecular weight Mwₐ and the number of functional groups falls within the foregoing range, a density of the crosslinking group becomes high, whereby a high hardness can be presented.

As the component (a), commercially available products can also be used. For example, as the polyfunctional acrylate based compound having a (meth)acryloyl group, there can be exemplified PET30, KAYARAD DPHA, KAYARAD DPCA-30, and KAYARAD DPCA-120, all of which are manufactured by Nippon Kayaku Co., Ltd. Also, as the urethane acrylate, there can be exemplified U15HA, U4HA, and A-9300, all of which are manufactured by Shin Nakamura Chemical Co., Ltd., and EB5129, manufactured by DAICEL UCB.

For the purpose of giving a sufficient rate of polymerization to impart a hardness or the like, a content of the component (a) in the hard coat layer forming composition according to the invention is preferably from 10 to 60% by mass, and more preferably from 20 to 55% by mass, relative to the whole of solids in the hard coat layer forming composition.

From the viewpoints of suppression of interference unevenness, hardness and curl, the hard coat layer forming composition according to the invention contains the component (a) in an amount of equal to or more than that of the component (b) as described later. A ratio (content of (a)/content of (b)) is 1.0 or more, preferably more than 2.0, and more preferably more than 3.5.

### [(b) Urethane Compound Having Three or More Functional Groups in One Molecule Thereof]

The component (b) which is contained in the hard coat layer forming composition according to the invention is described.

The component (b) which is used in the invention is a compound having three or more functional groups in one molecule thereof and having an SP value SP_{b} according to the Hoy method satisfying a relation of 19<SP_{b}<25 and a mass average molecular weight Mw_{b} satisfying a relation of 150≦|Mw_{b}−Mwₐ≦500.

The component (b) is a compound in which an absolute value of a difference in mass average molecular weight from the component (a) is 150 or more and not more than 500. As described previously, since there is a difference of the specified range in the mass average molecular weight between the component (a) and the component (b), the permeability into the cellulose ester film base material is different therebetween. For that reason, a gradation region is formed between the cellulose ester film base material and the hard coat layer, and the interference unevenness can be suppressed. Also, the component (b) is a compound having three or more functional groups in one molecule thereof, and it can function as a binder and a curing agent of the hard coat layer and makes it possible to enhance the strength or resistance to scuffing of a coating film.

Specific examples and preferred range of the polymerizable functional group which the component (b) has are the same as those in the foregoing component (a). Also, specific examples and commercially available products of the component (b) are the same as the specific examples and commercially available products of the urethane compound described above for the component (a).

In the hard coat layer forming composition according to the invention, the component (b) is a urethane compound.

The urethane compound is preferably a compound containing two urethane bonds. Also, the urethane compound is preferably one having a (meth)acryloyl group, and more preferably polyurethane polyacrylate.

As for the mass average molecular weight Mw_{b} of the component (b), an absolute value of a difference from the mass average molecular weight Mw_{b} of the component (a) satisfies a relation of 150≦|Mw_{b}−Mwₐ|≦500. From the viewpoints of suppressing the interference unevenness due to the formation of a gradation region and enhancing the hardness of the hard coat layer, a relation of 150≦|Mw_{b}−Mwₐ|≦450 is preferable, and a relation of 200≦|Mw_{b}−Mwₐ|≦450 is more preferable.

Incidentally, the mass average molecular weight is a mass average molecular weight as reduced into polystyrene, which is measured by means of gel permeation chromatography.

When a difference in the mass molecular weight is present as described previously, there are obtained two kinds of monomer distributions which are different from each other to some extent due to a difference in permeability into the base material between the two kinds of monomers and which do not smoothly change in the film thickness direction. Then, since the affinity of the two kinds of monomers with the base material is good, and the both are easily mixed with each other, the distribution of the monomers and the base material smoothly changes in terms of a total of the film (namely, the refractive index continuously changes in the film thickness direction), and so speak, a gradation layer in which the refractive index continuously changes is formed, whereby the interference unevenness can be suppressed. However, when the molecular weight difference is too large or too small as compared with the foregoing value, the monomer distribution as a total of the film does not continuously change.

The SP value SP_{b} of the component (b) according to the Hoy method satisfies a relation of 19<SP_{b}<25. From the viewpoint of suppressing the interference unevenness due to the formation of a gradation region, a relation of 19.5<SP_{b}<24.5 is preferable, and a relation of 20<SP_{b}<24.5 is more preferable.

Incidentally, the SP value (solubility parameter) in the invention is a value calculated according to the Hoy method, and the Hoy method is described in POLYMER HANDBOOK FOURTH EDITION.

A ratio of the mass average molecular weight Mw_{b} and the number of functional groups in one molecule of the component (b) satisfies preferably a relation of 70<(Mw_{b}/(number of functional groups in one molecule))<300, more preferably a relation of 70<(Mw_{b}/(number of functional groups in one molecule))<290, and still more preferably a relation of 70<(Mw_{b}/(number of functional groups in one molecule))<280. When the ratio of the mass average molecular weight Mw_{b} and the number of functional groups falls within the foregoing range, a density of the crosslinking group becomes high, whereby a high hardness can be presented.

For the purpose of giving a sufficient rate of polymerization to impart a hardness or the like, a content of the component (b) in the hard coat layer forming composition of the invention is preferably from 5.0 to 30% by mass, and more preferably from 5.0 to 15% by mass, relative to the whole of solids in the hard coat layer forming composition. Also, a ratio in the content of the component (a) and the component (b) in the hard coat layer forming composition of the invention is one described previously.

### [(c) Solvent Having Dissolving Ability Against the Base Material]

The solvent (c) having dissolving ability against the base material, which is contained in the hard coat layer forming composition according to the invention, is described.

The solvent (c) which is used for the hard coat layer forming composition of the invention is a solvent having dissolving ability against the base material.

In the invention, when the solvent (c) and the solvent (d) having swelling ability against the base material as described later are used, interfacial reflection between the transparent base material and the hard coat layer is suppressed, and interference unevenness can be effectively suppressed.

The solvent having dissolving ability against the base material as referred to herein means a solvent having such properties that when a base material film having a size of 24 mm×36 mm (thickness: 80 μm) is dipped in a 15-cc bottle having the solvent charged therein at room temperature (25° C.) for 60 seconds and then taken out, and thereafter, when the dipped solution is analyzed by means of gel permeation chromatography (GPC), a peak area of the base material component is 400 mV/sec or more. Alternatively, the solvent having dissolving ability against the base material as referred to herein means a solvent having such properties that when a base material film having a size of 24 mm×36 mm (thickness: 80 μm) is allowed to elapse in a 15-cc bottle having the solvent charged therein at room temperature (25° C.) for 24 hours, and the film loses its form upon being completely dissolved by properly swinging the bottle or other means, the dissolving ability against the base material is still kept.

The solvent (c) may be used solely or in combination of two or more kinds thereof.

The solvent having dissolving ability is hereunder exemplified by reference to the case of using a triacetyl cellulose film as the transparent base material as an example.

Examples of the solvent (c) having dissolving ability against the base material include methyl acetate, acetone, and methylene chloride. Above all, from the viewpoint of suppressing the interference unevenness due to the formation of a gradation region, methyl acetate or acetone is preferable.

From the viewpoint of suppressing the interference unevenness due to the formation of a gradation region between the transparent base material and the hard coat layer, the solvent (c) preferably includes at least one member of methyl acetate and acetone, and more preferably includes methyl acetate.

### [(d) Solvent Having Swelling Ability Against the Base Material]

The solvent (d) having swelling ability against the base material, which is contained in the hard coat layer forming composition according to the invention, is described.

The solvent (d) which is used for the hard coat layer forming composition of the invention is a solvent having swelling ability against the base material.

In the invention, when the solvent (c) and the solvent (d) having swelling ability against the base material as described later are used, interfacial reflection between the transparent base material and the hard coat layer is suppressed, and interference unevenness can be effectively suppressed.

Here, the solvent having swelling ability against the base material as referred to in the invention means a solvent having such properties that when a base material film having a size of 24 mm×36 mm (thickness: 80 μm) is charged vertically in a 15-cc bottle having the solvent charged therein, dipped at 25° C. for 60 seconds and observed while properly swinging the bottle, bending or deformation is found (in the film, the size of a swollen portion thereof changes, and bending or deformation is observed; whereas in a solvent having no swelling ability, a change such as bending and deformation is not found).

The solvent (d) may be used solely or in combination of two or more kinds thereof.

The solvent having swelling ability is hereunder exemplified by reference to the case of using a triacetyl cellulose film as the transparent base material as an example.

Examples of the solvent (d) having swelling ability against the cellulose acylate film include methyl ethyl ketone (MEK).

Also, examples of a solvent having neither dissolving ability nor swelling ability against the cellulose acylate film include methyl isobutyl ketone (MIBK).

In the invention, such a solvent having neither dissolving ability nor swelling ability can be used so far as the effects of the invention are not impaired. An addition amount of the solvent having neither dissolving ability nor swelling ability is preferably not more than 10% by mass, more preferably not more than 5% by mass, and still more preferably not more than 1% by mass relative to the whole of solvents used for the purpose of obtaining the effects of the solvents having dissolving ability and swelling ability, respectively.

From the viewpoint of suppressing interference unevenness due to the formation of a gradation region between the transparent base material and the hard coat layer, it is preferable that the solvent includes at least one member of methyl acetate, acetone, and methyl ethyl ketone. The solvent is preferably a mixed solvent including methyl acetate or acetone (the solvent (c)) and methyl ethyl ketone (the solvent (d)).

From the viewpoint of suppressing interference unevenness due to the formation of a gradation region between the transparent base material and the hard coat layer, it is preferable that the content of the solvent (c) is larger than the content of the solvent (d). From the viewpoints of formation of a gradation region suitable for suppressing interference unevenness and film hardness of the hard coat layer, it is preferable that a ratio of the content of the solvent (c) to the content of the solvent (d) is from 50/50 to 95/5.

However, in the case where a drying rate of the solvent can be delayed by increasing the film surface temperature of the hard coat layer or raising a circumferential gas concentration during coating the hard coat layer forming composition, it may be considered that even when the content of the solvent (c) is small, the objects of the invention can be achieved.

An amount of the whole of solvents in the hard coat layer forming composition according to the invention is in the range of preferably from 1 to 70% by mass, more preferably from 20 to 70% by mass, still more preferably from 40 to 70% by mass, yet still more preferably from 45 to 65% by mass, even yet still more preferably from 50 to 65% by mass, and most preferably from 55 to 65% by mass in terms of a concentration of solids in the composition.

### [(e) Photopolymerization Initiator]

It is preferable that the hard coat layer forming composition according to the invention includes (e) a photopolymerization initiator.

Examples of the photopolymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, oniums, borate salts, active esters, active halogens, inorganic complexes, and coumarins. Specific examples, preferred embodiments, commercially available products, and so on of the photopolymerization initiator are described in paragraphs [0133] to [0151] of JP-A-2009-098658 and can also be similarly suitably applied in the invention.

A variety of examples are described in Saishin UV Koka Gijutsu (Latest UV Curing Technologies), page 159 (1991) (published by Technical Information Institute Co., Ltd.); and Shigaisen Koka Shisutemu (Ultraviolet Ray Curing Systems), pages 65 to 148 (1989) (written by Kiyoshi Kato and published by Sogo Gijutsu Center) and are useful in the invention.

A content of the photopolymerization initiator in the hard coat layer forming composition according to the invention is preferably from 0.5 to 8% by mass, and more preferably from 1 to 5% by mass for the reason that it is sufficiently large for polymerizing the polymerizable compounds contained in the hard coat layer forming composition and sufficiently small such that starting points do not excessively increase.

### [(f) Leveling Agent]

A leveling agent (f) which may be contained in the hard coat layer forming composition according to the invention is described.

It is preferable that the leveling agent is at least one of the following fluorine-containing polymer (1) and fluorine-containing polymer (2).

The fluorine-containing polymer (1) is a polymer containing a polymerization unit derived from a fluoroaliphatic group-containing monomer represented by the following general formula [1] in an amount of more than 50% by mass relative to the whole of polymerization units.

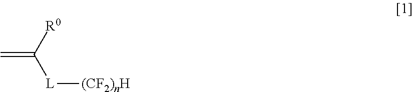

In the general formula [1], R⁰ represents a hydrogen atom, a halogen atom, or a methyl group; L represents a divalent connecting group; and n represents an integer of 1 or more and not more than 18.

In the fluorine-containing polymer (1), though the content of the repeating unit derived from the fluoroaliphatic group-containing monomer represented by the general formula [1] exceeds 50% by mass relative to the whole of polymerization units constituting the fluorine-containing polymer (1), it is preferably 70% by mass or more, and more preferably 80% by mass or more.

In the general formula [1], R⁰ represents a hydrogen atom, a halogen atom, or a methyl group, and more preferably a hydrogen atom or a methyl group.

n represents an integer of 1 or more and not more than 18, more preferably from 4 to 12, still more preferably from 6 to 8, and most preferably 8.

Also, the polymerization unit of the fluoroaliphatic group-containing monomer represented by the general formula [1] may be contained as two or more kinds of constituent units in the fluorine-containing polymer (1).

In the fluorine-containing polymer (1), the general formula [1] is preferably the following general formula [1-2].

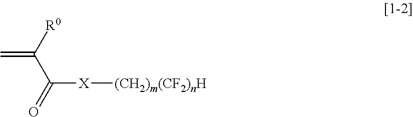

In the general formula [1-2], R⁰ represents a hydrogen atom, a halogen atom, or a methyl group; X represents an oxygen atom, a sulfur atom, or —N(R²)—; m represents an integer of 1 or more and not more than 6; and n represents an integer of 1 or more and not more than 18. Here, R² represents a hydrogen atom or an alkyl group having from 1 to 8 carbon atoms, which may have a substituent.

In the general formula [1-2], R⁰ represents a hydrogen atom, a halogen atom, or a methyl group, and more preferably a hydrogen atom or a methyl group.

X represents an oxygen atom, a sulfur atom, or —N(R²)—, more preferably an oxygen atom or —N(R²)—, and still more preferably an oxygen atom. R² represents a hydrogen atom or an alkyl group having from 1 to 8 carbon atoms, which may have a substituent, and examples of the substituent include a phenyl group and a benzyl group. R² is more preferably a hydrogen atom or an alkyl group having from 1 to 4 carbon atoms, which may have a substituent, and still more preferably a hydrogen atom or a methyl group.

m represents an integer of from 1 to 6, more preferably from 1 to 3, and still more preferably 1.

n represents an integer of from 1 to 18, more preferably from 4 to 12, still more preferably from 6 to 8, and most preferably 8.

The polymerization unit of the fluoroaliphatic group-containing monomer represented by the general formula [1-2] may be contained as two or more kinds of constituent units in the fluorine-containing polymer (1).

Next, the fluorine-containing polymer (2) is described.

The fluorine-containing polymer (2) is a polymer containing a polymerization unit derived from a fluoroaliphatic group-containing monomer represented by the following general formula [2] and at least one of a poly(oxyalkylene) acrylate and a poly(oxyalkylene) methacrylate.

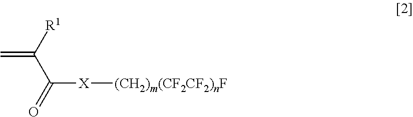

In the general formula [2], R¹ represents a hydrogen atom or a methyl group; X represents an oxygen atom, a sulfur atom, or —N(R²)—; m represents an integer of 1 or more and not more than 6; n represents an integer of 1 to 3; and R² represents a hydrogen atom or an alkyl group having from 1 to 4 carbon atoms.

It is preferable that one of the fluoroaliphatic groups in the fluorine-containing polymer (2) is derived from a fluoroaliphatic compound manufactured by a telomerization method (also called “telomer method”) or an oligomerization method (also called “oligomer method”). Production methods of such a fluoroaliphatic compound are described in, for example, Fusso Kagobutsu No Gosei To Kino (Syntheses and Functions of Fluorine Compounds) (compiled by Nobuo Ishikawa, published by CMC Publishing Co., Ltd., 1987), pages 117 to 118; and Chemistry of Organic Fluorine Compounds II (Monograph 187, edited by Milos Hudlicky and Attila E. Pavlath, American Chemical Society, 1995), pages 747 to 752.

As specific examples of the foregoing fluoroaliphatic group-containing monomers [1] and [2] and fluorine-containing polymers (1) and (2), there can be exemplified the specific examples described in JP-A-2010-1549434, JP-A-2010-121137, JP-A-2004-331812, and JP-A-2004-163610. However, it should not be construed that the invention is limited thereto.

Also, fluoroaliphatic group-containing polymers described in Japanese Patent No. 4474114 are preferable as the leveling agent. Fluoroaliphatic group-containing polymers having a ratio of the fluoroaliphatic group-containing polymerization unit in the range of from 50 to 70%, a composition ratio of which is, however, different from that of the fluoroaliphatic group-containing polymers described in Japanese Patent No. 4474114, can also be used as the leveling agent.

In the invention, in order to dissolve coating unevenness of the hard coat layer, it is desirable that a sufficient amount of the leveling agent is applied on the surface of the hard coat layer. However, at the time of stacking an antireflection layer on the hard coat layer, when the leveling agent contained in the hard coat layer remains at the interface between the hard coat layer and the antireflection layer, the adhesion is deteriorated, and the resistance to scuffing is conspicuously impaired. For that reason, it is important that at the time of stacking an antireflection layer, the leveling agent is quickly extracted into the antireflection layer and does not remain at the interface. In view of the fact that an end of the fluoroaliphatic group of the fluorine-containing polymer (1) is a hydrogen atom, the fluorine-containing polymer (1) hardly repels a coating liquid of the upper layer as compared with the fluorine-containing polymer (2) in which an end thereof is a fluorine atom, is quickly extracted into the upper layer and hardly remains at the interface between the antireflection layer and the hard coat layer. For these reasons, the fluorine-containing polymer (1) is more preferable.

A content of the leveling agent in the hard coat layer forming composition according to the invention is preferably from 0.0005% by mass to 2.5% by mass, and more preferably from 0.005% by mass to 0.5% by mass, relative to the whole of solids in the hard coat layer forming composition for the reason that it is necessary to impart sufficient leveling properties, thereby improving coating unevenness and to set up the content of the leveling agent sufficiently low so as to not remain at the interface between the hard coat layer and other layer.

### [(g) Silica Fine Particle]

A size (primary particle diameter) of a silica fine particle which can be used for the hard coat layer forming composition according to the invention is 15 nm or more and less than 100 nm, more preferably 20 nm or more and not more than 80 nm, and most preferably 25 nm or more and not more than 60 nm. An average particle diameter of the fine particle can be determined from an electron microscopic photograph. When the particle diameter of the inorganic fine particle is too small, an effect for increasing surface uneven distribution of the leveling agent becomes low, whereas when it is too large, fine concaves and convexes are formed on the surface of the hard coat layer, an appearance such as denseness of black and integral reflectance are deteriorated. The silica fine particle may be either crystalline or amorphous, and also, it may be a monodispersed particle. So far as the prescribed particle diameter is satisfied, the silica fine particle may also be an aggregated particle. Though its shape is most preferably spherical, there is no problem even if the shape is one other than a spherical shape such as an amorphous shape. Also, two or more kinds of silica fine particles having a different average particle size from each other may be used in combination.

For the purposes of enhancing dispersibility in the coating liquid and enhancing the film strength, the silica fine particle which can be used in the invention may be subjected to a surface treatment. Specific examples of the surface treatment method and preferred examples thereof are the same as those described in paragraphs [0119] to [0147] of JP-A-2007-298974.

As specific examples of the silica fine particle, MiBK-ST and MiBK-SD (both of which are a silica sol having an average particle diameter of 15 nm, manufactured by Nissan Chemical Industries, Ltd.), MEK-ST-L (a silica sol having an average particle diameter of 50 nm, manufactured by Nissan Chemical Industries, Ltd.), and so on can be preferably used.

The hard coat layer forming composition according to the invention can further contain additives in addition to the foregoing components. As additives which can be further contained, for the purpose of suppressing decomposition of the polymer, there can be exemplified an ultraviolet ray absorber, a phosphorous acid ester, hydroxamic acid, hydroxylamine, imidazole, hydroquinone, and phthalic acid. Also, there can be exemplified an inorganic fine particle, a polymer fine particle, and a silane coupling agent for the purpose of increasing the film strength; a fluorine based compound (in particular, a fluorine based surfactant) for the purpose of decreasing a refractive index to increase transparency; and a mat particle for the purpose of imparting internal scattering properties.

### [Layer Configuration of Optical Film]

In an embodiment of the optical film of the invention, the optical film has a hard coat layer formed by using the foregoing hard coat layer forming composition, on a transparent base material.

The optical film of the invention has a hard coat layer on a transparent base material and may be further provided with a single layer or plural layers of necessary functional layers depending upon the purpose. For example, an antireflection layer (a layer having an adjusted refractive index, such as a low refractive index layer, a middle refractive index layer, and a high refractive index layer), an antiglare layer, and so on can be provided.

Examples of a more specific layer configuration of the optical film of the invention are given below.
Transparent base material/hard coat layer
Transparent base material/hard coat layer/low refractive index layer
Transparent base material/hard coat layer/high refractive index layer/low refractive index layer
Transparent base material/hard coat layer/middle refractive index layer/high refractive index layer/low refractive index layer

### [Transparent Base Material]

In the optical film of the invention, though a variety of materials can be used as the transparent base material (support), a cellulose ester film is preferable. It is more preferable to use a cellulose acylate film.

Though the cellulose acylate film is not particularly limited, in the case of being placed on a display, a cellulose triacetate film is especially preferable from the standpoint of productivity or costs because the cellulose triacetate film can be used as it is as a protective film for protecting a polarizing layer of a polarizing plate.

Though a thickness of the transparent base material is usually from about 25 μm to 1,000 μm, it is preferably from 25 μm to 200 μm at which not only handling properties are satisfactory, but a necessary base material strength is obtainable. It is more preferably from 25 μm to 120 μm, still more preferably from 25 μm to 100 μm, especially more preferably 30 μm to 90 μm, and most preferably from 35 μm to 80 μm.

### (Cellulose Acylate)

In the invention, it is preferable to use cellulose acetate having a degree of acetylation of from 59.0 to 61.5% for the cellulose acylate film. The degree of acetylation as referred to herein means an amount of combined acetic acid per unit mass of cellulose. The degree of acetylation follows the measurement and calculation of a degree of acylation in accordance with ASTM D-817-91 (testing method for cellulose acetate and the like). A viscosity average degree of polymerization (DP) of the cellulose acylate is preferably 250 or more, and more preferably 290 or more.

Also, in the cellulose acylate which is used in the invention, it is preferable that an Mw/Mn value according to the gel permeation chromatography (Mw represents a mass average molecular weight, and Mn represents a number average molecular weight) is close to 1.0, in other words, the molecular weight distribution is narrow. Specifically, the Mw/Mn value is preferably from 1.0 to 1.7, more preferably from 1.3 to 1.65, and most preferably from 1.4 to 1.6.

In general, it is not the case where the hydroxyl groups at the 2-, 3- and 6-positions of the cellulose acylate are evenly distributed every ⅓ of a substitution degree of the whole, but the substitution degree of the hydroxyl group at the 6-position tends to become small. In the invention, it is preferable that the substitution degree of the hydroxyl group at the 6-position of the cellulose acylate is larger than that of the hydroxyl group at each of the 2- and 3-positions.

The hydroxyl group at the 6-position is substituted with the acyl group at a ratio of preferably 32% or more, more preferably 33% or more, and especially preferably 34% or more relative to the substitution degree of the whole. Furthermore, a substitution degree of the acyl group at the 6-position of the cellulose acylate is preferably 0.88 or more. The hydroxyl group at the 6-position may also be substituted with an acyl group having 3 or more carbon atoms other than the acetyl group, such as a propionyl group, a butyroyl group, a valeroyl group, a benzoyl group, and an acryloyl group. The measurement of the substitution degree at each position can be achieved by means of NMR.

In the invention, cellulose acetates obtained by the methods described in Synthesis Example 1 of EXAMPLES in paragraphs [0043] to [0044], Synthesis Example 2 in paragraphs [0048] to [0049], and Synthesis Example 3 in paragraphs [0051] to [0052] of JP-A-11-5851 can be used as the cellulose acylate.

### [Raw Material Cotton of Cellulose Acylate]

Examples of the cellulose as a raw material of the cellulose acylate which is used in the invention include cotton linter and wood pulps (for example, hardwood pulps and soft wood pulps), and cellulose acylates obtained from any of these raw material celluloses can be used. As the case may be, a mixture thereof may be used. These raw material celluloses are described in detail in, for example, Course of Plastic Materials (17): Cellulose Resins (written by Marusawa and Uda and published by The Nikkan Kogyo Shimbun, Ltd. (1970)); and Journal of Technical Disclosure, No. 2001-1745 (pages 7 to 8) by Japan Institute of Invention and Innovation. But, it should be construed that the cellulose acylate to be used for the cellulose acylate film is not particularly limited thereto.

### [Substitution Degree of Cellulose Acylate]

Next, the cellulose acylate in the invention which is manufactured using the foregoing cellulose as a raw material is described. The cellulose acylate in the invention is one obtained by acylating the hydroxyl groups of cellulose, and any acyl groups including from an acetyl group having two carbon atoms to one having 22 carbon atoms can be used as a substituent thereof. In the cellulose acylate of the invention, as a measurement method of the substitution degree of acetic acid and/or a fatty acid having from 3 to 22 carbon atoms which substitutes on the hydroxyl groups of the cellulose, there can be exemplified a method in accordance with ASTM F-817-91 and an NMR method.

In the cellulose acylate in the invention, the substitution degree on the hydroxyl groups of the cellulose is not particularly limited. However, in the case of being used for an application of a protective film for polarizing plate or an optical film, a higher degree of acyl substitution is preferable because excellent moisture permeability or hygroscopicity of the film is revealed. For that reason, the degree of acyl substitution on the hydroxyl groups of the cellulose is preferably from 2.50 to 3.00, more preferably from 2.70 to 2.96, and still more preferably from 2.80 to 2.94.

Of acetic acid and/or a fatty acid having from 3 to 22 carbon atoms which substitutes on the hydroxyl groups of the cellulose, the acyl group having from 2 to 22 carbon atoms is not particularly limited and may be either an aliphatic group or an aromatic group, and it may be used solely or in admixture of two or more kinds thereof. Examples thereof include alkyl carbonyl esters, alkenyl carbonyl esters, aromatic carbonyl esters or aromatic alkyl carbonyl esters of cellulose. Such an ester may further have a substituted group. As the preferred acyl group, there can be exemplified acetyl, propionyl, butanoyl, heptanoyl, hexanoyl, octanoyl, decanoyl, dodecanoyl, tridecanoyl, tetradecanoyl, hexadecanoyl, octadecanoyl, isobutanoyl, t-butanoyl, cyclohexanecarbonyl, oleoyl, benzoyl, naphthylcarbonyl, and cinnamoyl groups. Of these, acetyl, propionyl, butanoyl, dodecanoyl, octadecanoyl, t-butanoyl, oleoyl, benzoyl, naphthylcarbonyl, or cinnamoyl is preferable, and acetyl, propionyl, or butanoyl is more preferable.

Above all, from the viewpoints of easiness of synthesis, costs, easiness of control of substituent distribution, and so on, an acetyl group or a mixed ester of an acetyl group and a propyl group is preferable, and an acetyl group is especially preferable.

### [Degree of Polymerization of Cellulose Acylate]

A degree of polymerization of the cellulose acylate which is preferably used in the invention is from 180 to 700, and in cellulose acetate, it is more preferably from 180 to 550, still more preferably from 180 to 400, and especially preferably from 180 to 350, in terms of a viscosity average degree of polymerization. When the degree of polymerization is too high, a viscosity of a dope solution of the cellulose acylate becomes high, so that the film fabrication by means of casting tends to become difficult. When the degree of polymerization is too low, a strength of the fabricated film tends to be lowered. The average degree of polymerization can be measured by an intrinsic viscosity method by Uda, et al. (Kazuo Uda and Hideo Saito, Sen'i Gakkaishi (Journal of the Society of Fiber Science and Technology, Japan), Vol. 18, No. 1, pages 105 to 120 (1962)). Furthermore, this method is described in detail in JP-A-9-95538.

Also, the molecular weight distribution of the cellulose acylate which is preferably used in the invention is evaluated by means of gel permeation chromatography, and it is preferable that its polydispersity index Mw/Mn (Mw represents a mass average molecular weight, and Mn represents a number average molecular weight) is small, and the molecular weight distribution is narrow. Specifically, the Mw/Mn value is preferably 1.0 to 4.0, more preferably from 2.0 to 3.5, and most preferably from 2.3 to 3.4.

When a low-molecular weight component is removed, while the average molecular weight (degree of polymerization) becomes high, the viscosity becomes lower than that of usual cellulose acylates, and such is useful. The cellulose acylate having a few of a low-molecular weight component can be obtained by removing the low-molecular weight component from a cellulose acylate synthesized by a usual method. The removal of the low-molecular weight component can be carried out by washing the cellulose acylate with an appropriate organic solvent. Incidentally, in the case of manufacturing a cellulose acylate having a few of a low-molecular weight component, it is preferable to adjust an amount of a sulfuric acid catalyst in the acetylation reaction at from 0.5 to 25 parts by mass based on 100 parts by mass of the cellulose. When the amount of the sulfuric acid catalyst is made to fall within the foregoing range, it is possible to synthesize a cellulose acylate which is also preferable from the standpoint of molecular weight distribution (the molecular weight distribution is narrow). During the use at the time of manufacturing the cellulose acylate film in the invention, a water content of the cellulose acylate is preferably not more than 2% by mass, more preferably not more than 1% by mass, and especially preferably not more than 0.7% by mass. In general, a cellulose acylate contains water, and it is known that its water content is from 2.5 to 5% by mass. In the invention, in order to allow the cellulose acylate to have the foregoing water content, it is necessary to achieve drying, and a method for achieving drying is not particularly limited so far as the desired water content is presented. In the invention, as for such a cellulose acylate, its raw material cotton and synthesis method are described in detail on pages 7 to 12 of Journal of Technical Disclosure, No. 2001-1745, issued on Mar. 15, 2001 by Japan Institute of Invention and Innovation.

In the invention, from the viewpoints of substituent, substitution degree, degree of polymerization, molecular weight distribution, and so on, the cellulose acylate can be used solely or two or more kinds of different cellulose acylates.

### [Polyester Diol Additive]

A polyester diol additive which is used in the invention is described.

As the polyester diol additive, one having compatibility with the cellulose acylate dope and the cellulose acylate film can be chosen with respect to its structure, molecular weight and addition amount so as to satisfy desired optical characteristic.

From the standpoint of making both compatibility with the cellulose acylate dope and the cellulose acylate film and control of optical characteristics compatible with each other, it is preferable that the polyester diol which is used in the invention has an alcoholic hydroxyl group at the both ends of a principal chain thereof.

In particular, it is necessary that the addition amount of the polyester diol is 5% by mass or more relative to the cellulose acylate. The addition amount of the polyester diol is preferably from 9 to 40% by mass, and more preferably from 10 to 30% by mass.

In the cellulose acylate film of the invention, in order to keep the material quality constant, it is important to control a hydroxyl value (OHV) and a molecular weight of the polyester diol to fixed ranges with regards to control of optical anisotropy. In particular, the hydroxyl value is also preferable for the quality control. For the measurement of the hydroxyl value, an acetic anhydride method described in the Japanese Industrial Standards JIS K 1557-1:2007, or the like can be applied.

The hydroxyl value is preferably 40 mg KOH/g or more and not more than 170 mg KOH/g, more preferably 60 mg KOH/g or more and not more than 150 mg KOH/g, and especially preferably 90 mg KOH/g or more and not more than 140 mg KOH/g.

When the hydroxyl value is too large, there is unpreferable tendency such that the molecular weight is low, the amount of a low-molecular weight component increases, and volatility becomes large. Also, when the hydroxyl value is too small, there is unpreferable tendency such that solubility in a solvent or compatibility with the cellulose acylate becomes worse.

A number average molecular weight (Mn) of the polyester diol in the invention can be determined by means of calculation from the hydroxyl value or measurement of GPC. A value of the molecular weight is preferably 650 or more and not more than 2,800, more preferably 700 or more and not more than 2,000, and especially preferably 800 or more and not more than 1,250. Also, in order to reveal optical isotropy, the molecular weight value is especially suitably 800 or more and not more than 1,200.

The polyester diol which is used in the invention can be manufactured by a known method such as dehydration condensation reaction of a dibasic acid and a glycol; and addition of an anhydrous dibasic acid to a glycol and dehydration condensation reaction.

Here, as the dibasic acid constituting the polyester diol which is used in the invention, there can be exemplified succinic acid, glutaric acid, adipic acid, and maleic acid. Such a dibasic acid is used solely or in combination of two or more kinds thereof. For example, succinic acid, adipic acid, or a mixture thereof is preferably used.

A carbon number of the dibasic acid is preferably from 4 to 8, more preferably from 4 to 6, and especially preferably 6. What the carbon number is small is suitable because of the fact that a degree of moisture permeation of the cellulose acylate film can be decreased and also from the standpoint of compatibility. From the standpoints of costs and easiness of handling of the polyester diol, the carbon number of the dibasic acid is preferably 6.

Also, as the glycol constituting the polyester diol which is used in the invention, a suitable glycol can be selected among a variety of glycols such as ethylene glycol, diethylene glycol, 1,2-propylene glycol, 1,3-propylene glycol, and butylene glycol. Of these, glycols having from 2 to 4 carbon atoms are preferable, and ethylene glycol having two carbon atoms is especially preferable. This is because a glycol having a small carbon number is excellent in compatibility with the cellulose ester dope or the cellulose ester film and excellent in bleed-out resistance due to a moist heat thermostat.

### [Additive]

To the cellulose acylate film in the invention, not only the polyester diol described previously, but further, a low-molecular weight or oligomer, or high molecular weight additive can be added as a plasticizer, a wavelength dispersion control agent, a light resistance improver, a mat agent, an optical anisotropy adjusting agent, or the like according to the intended purpose.

[Optical anisotropy adjusting agent]

As an example of such an additive, an optical anisotropy adjusting agent is described. The optical anisotropy of the cellulose ester film of the invention is controlled by the structure of the polyester diol described previously. However, a different optical anisotropy adjusting agent may be further added thereto. For example, mention may be made of the compounds for reducing Rth described on pages 23 to 72 of JP-A-2006-30937 as examples.

### [Cellulose Acylate Film Having Small Optical Anisotropy]

The cellulose acylate film in the invention is especially suitably one having small optical anisotropy. It is preferably formed such that Re and Rth measured at a wavelength of 590 nm (defined by the following expressions (I) and (II)) satisfy both of the expression (III) and the expression (IV). This value can be controlled by the substitution degree of cellulose ester cotton, the addition amount of the foregoing polyester diol, the type and the amount of the optical anisotropy adjusting agent, the thickness of the film, or the like. In particular, the polyester diol which is used in the invention is an additive excellent in this control.

Re=(nx−ny)×d Expression (I)

Rth={(nx+ny)/2−nz}×d Expression (II)

|Re|<10 (nm) Expression (III)

|Rth|<25 (nm) Expression (IV)

In the foregoing expressions, nx represents a refractive index in a slow axis direction in the film plane; ny represents a refractive index in a fast axis direction in the film plane; nz represents a refractive index in a thickness direction of the film; and d represents a thickness (nm) of the film.

### [Wavelength Dispersion Adjusting Agent]

Also, as an example of such an additive, a compound for reducing the wavelength dispersion (hereinafter also referred to as “wavelength dispersion adjusting agent”) for making the cellulose acylate film in the invention more isotropic can be added. The wavelength dispersion adjusting agent is hereunder described.

The wavelength dispersion adjusting agent contains at least one compound which has absorption in an ultraviolet region at from 200 to 400 nm and reduces |Re (400)−Re (700)| and |Rth (400)−Rth (700)| of the film in an amount of from 0.01 to 30% by mass relative to the solids content of the cellulose acylate, whereby the wavelength dispersion of Re and Rth of the cellulose acylate film can be adjusted. (Here, Re (λ) and Rth (λ) are values of Re and Rth at a wavelength of λ nm, respectively.)

Also, in recent years, for liquid crystal display devices such as a television receiver, a laptop personal computer, and a mobile type portable terminal, in order to enhance the luminance with a low electric power, there are demanded those excellent in transmittance of an optical member to be used in each liquid crystal display device. For the cellulose acylate film of the invention, it is desirable that a spectral transmittance at a wavelength of 380 nm is 45% or more and not more than 95%, and a spectral transmittance at a wavelength of 350 nm is not more than 10%.

It is preferable that the wavelength dispersion adjusting agent which is preferably used in the invention as described above does not volatilize in processes of dope casting and drying of the fabrication of the cellulose acylate film. From the viewpoint of volatility, a molecular weight of the wavelength dispersion adjusting agent is preferably 250 or more, more preferably 300 or more, still more preferably 350 or more, and especially preferably 400 or more. When the molecular weight of the wavelength dispersion adjusting agent falls within the foregoing range, the wavelength dispersion adjusting agent may have a specified monomer structure, or may have an oligomer structure or a polymer structure in which a plurality of the monomer units are combined.

### (Addition Amount of Wavelength Dispersion Adjusting Agent)

An addition amount of the wavelength dispersion adjusting agent which is preferably used in the invention is preferably from 0.01 to 30% by mass, more preferably from 0.1 to 20% by mass, and especially preferably from 0.2 to 10% by mass of the cellulose acylate.

### (Method of Adding Compounds)

Also, such a wavelength dispersion adjusting agent may be used solely, or may be used in admixture of two or more kinds of the compounds in an arbitrary ratio.

Also, the timing of adding the wavelength dispersion adjusting agent may be any timing of the dope fabricating step, or addition of the wavelength dispersion adjusting agent may be carried out in a final stage of the dope preparation step.

Specific examples of the wavelength dispersion adjusting agent which is preferably used in the invention include benzotriazole based compounds, benzophenone based compounds, triazine based compounds, cyanoacrylate based compounds, salicylic acid ester based compounds, and nickel complex salt based compounds. However, it should not be construed that the invention is not limited only to these compounds.

### [Mat Agent Fine Particle]

To the cellulose acylate film in the invention, it is preferable to add a fine particle as a mat agent. As the fine particle which is used in the invention, there can be exemplified those made of silicon dioxide, titanium dioxide, aluminum oxide, zirconium oxide, calcium carbonate, talc, clay, sintered kaolin, sintered calcium silicate, hydrated calcium silicate, aluminum silicate, magnesium silicate, or calcium phosphate. As the fine particle, one containing silicon is preferable because of its low turbidity, and silicon dioxide is especially preferable. The fine particle of silicon dioxide has a primary average particle diameter of not more than 20 nm and an apparent specific gravity of 70 g/L or more. One having an average diameter of primary particle of as small as from 5 to 16 nm is more preferable because it can reduce the haze of the film. The apparent specific gravity is preferably from 90 to 200 g/L or more, and more preferably from 100 to 200 g/L or more. One with a larger apparent specific gravity is preferable because it can form a high-concentration dispersion liquid, resulting in improvements of the haze and the aggregate.

In general, such a fine particle forms a secondary particle having an average particle diameter of from 0.1 to 3.0 μm. Such a fine particle is present in the form of an aggregate of primary particles in the film, and it forms concaves and convexes of from 0.1 to 3.0 μm on the film surface. The secondary average particle diameter is preferably 0.2 μm or more and not more than 1.5 μm, more preferably 0.4 μm or more and not more than 1.2 μm, and most preferably 0.6 μm or more and not more than 1.1 μm. The primary or secondary particle diameter is defined as follows. The particles in the film are observed by a scanning electron microscope, and a diameter of the circle circumscribing the particle is taken as the particle diameter. Also, 200 particles are observed while changing the site. An average value thereof is taken as the average particle diameter.

As the fine particle of silicon dioxide, there can be used commercially available products such as AEROSIL R972, R972V, R974, R812, 200, 200V, 300, R202, OX50, and TT600 (all of which are manufactured by Nippon Aerosil Co., Ltd.). The fine particle of zirconium oxide is commercially available under trade names of AEROSIL R976 and R811 (both of which are manufactured by Nippon Aerosil Co., Ltd.), and these commercially available products are usable.

Of these, AEROSIL 200V and AEROSIL R972V are a fine particle of silicon dioxide having a primary average particle diameter of not more than 20 nm and an apparent specific gravity of 70 g/L or more, and these are especially preferable because these have a large effect for reducing a coefficient of friction while keeping the turbidity of the optical film low.

In the invention, in order to obtain a cellulose acylate film having particles having a small secondary average particle diameter, there may be considered some techniques for preparing a dispersion liquid of fine particles. For example, there is a method in which a fine particle dispersion liquid obtained by stirring and mixing a solvent and a fine particle is previously formed; this fine particle dispersion liquid is added to a small amount of a separately prepared cellulose acylate solution and dissolved therein with stirring; and the resulting solution is further mixed with a main cellulose acylate dope solution. This method is a preferable preparation method from the standpoints that dispersibility of the silicon dioxide fine particle is good; and that the silicon dioxide fine particle is less likely aggregated again. Besides, there is another method in which a small amount of a cellulose ester is added to a solvent and dissolved therein with stirring; a fine particle is then added thereto and dispersed therein by using a dispersing machine, thereby taking the resulting dispersion as a fine particle-added solution; and this fine particle-added solution is then sufficiently mixed with a dope solution by using an inline mixer. Though the invention is not limited to these methods, a concentration of silicon dioxide at the time of mixing a silicon dioxide fine particle with a solvent or the like and dispersing therein is preferably from 5 to 30% by mass, more preferably from 10 to 25% by mass, and most preferably 15 to 20% by mass. A higher dispersion concentration is preferable because the solution turbidity becomes lower relative to the addition amount, resulting in improvements of the haze and the aggregate.

An addition amount of the mat agent in the final cellulose acylate dope solution is preferably from 0.01 to 1.0 g, more preferably from 0.03 to 0.3 g, and most preferably from 0.08 to 0.16 g per square meter. Also, in the case where the cellulose acylate film is formed by multiple layers, it is preferable to add the mat agent to only the layer on the surface side without adding to the inner layer(s). In that case, the addition amount of the mat agent to the surface layer is preferably 0.001% by mass or more and not more than 0.2% by mass, and more preferably 0.01% by mass or more and not more than 0.1% by mass.

As the solvents to be used for dispersion, lower alcohols are preferable. Examples thereof include methyl alcohol, ethyl alcohol, propyl alcohol, isopropyl alcohol, and butyl alcohol. Though other solvents than lower alcohols are not particularly limited, it is preferable to use the solvent which is used at the time of the film formation of a cellulose acylate.

### [Other Additives]

Besides the compound for reducing the optical anisotropy and the wavelength dispersion adjusting agent, to the cellulose acylate film in the invention, there can be added various additives (for example, a plasticizer, an ultraviolet ray absorber, a deterioration inhibitor, a release agent, and an infrared ray absorber) according to an application in each of the preparation steps. They may be either a solid or an oily substance. That is, though there is no particular limitation on the melting point or the boiling point, for example, mention may be made of mixing of ultraviolet ray absorbing materials of not higher than 20° C. and 20° C. or higher, respectively and similarly, mixing of a plasticizer. For example, they are described in JP-A-2001-151901, or the like. Moreover, the infrared ray absorbing dye is described in, for example, JP-A-2001-194522. Also, for the timing of addition, the additives may be added at any timing in the dope preparation step. However, a step of adding the additives for preparation may be added to a final preparation step in the dope preparation step for carrying out the addition. Still further, the addition amount of each raw material is not particularly limited so as as its function is revealed. Also, in the case where the cellulose acylate film is formed of multiple layers, the type and the addition amount of the additive in each layer may be different. Though these are described in, for example, JP-A-2001-151902, these are a conventionally known technique. For the details thereof, there can be preferably used materials described in details on pages 16 to 22 of Journal of Technical Disclosure, No. 2001-1745, issued on Mar. 15, 2001 by Japan Institute of Invention and Innovation.

### [Addition Amount of Additive]

In the cellulose acylate film of the invention, a total amount of compounds each having a molecular weight of not more than 5,000 is preferably from 0.1 to 45% by mass %, more preferably from 0.5 to 30% by mass, and still more desirably from 0.5 to 20% by mass relative to the mass of the cellulose acylate.

### <Sugar Ester Compound>

The optical film of the invention contains an aromatic sugar ester compound represented by the following general formula (I), an aromatic sugar ester compound represented by the following general formula (II), and an aliphatic sugar ester compound represented by the following general formula (III), and it is preferable that each of the aromatic sugar ester compound represented by the general formula (I) and the aromatic sugar ester compound represented by the general formula (II) has an average ester substitution degree of less than 94%.

(HO)ₘ-G-(L-R¹)ₙ General Formula (I)

(HO)ₚ-G-(L-R¹)_{q} General Formula (II)

(HO)ₜ-G′-(L′-R²)ᵣ General Formula (III)

In the general formulae (I) to (III), each of G and G′ independently represents a monosaccharide residue or a disaccharide residue. Each R¹ independently represents an aliphatic group or an aromatic group, and at least one R¹ represents an aromatic group. Each R² independently represents an aliphatic group. Each of L and L′ independently represents a divalent connecting group. m represents an integer of 0 or more; each of n, p, and q independently represents an integer of 1 or more; r represents an integer of 3 or more; and t represents an integer of 0 or more, provided that (m+n)≧4, (p+q)≧4, m>p, and n<q. Also, each of (m+n) and (p+q) is equal to a number of hydroxyl groups in the case of supposing that G is not a residue but an unsubstituted saccharide of a cyclic acetal structure of the same skeleton; and (r+t) is equal to a number of hydroxyl groups in the case of supposing that G′ is not a residue but an unsubstituted saccharide of a cyclic acetal structure of the same skeleton.

Specifically, in the invention, it is preferable to use a sugar ester compound mixture obtained by mixing a plurality of the aromatic sugar ester compounds having a different ester substitution degree from each other and the aliphatic sugar ester compound so as to satisfy the foregoing conditions. By adding the foregoing sugar ester compound mixture to the cellulose ester film, it is possible to obtain a cellulose ester film which is less in planar failure and small in change with time of optical performance and which when incorporated as a protective film into a polarizing plate, is small in change with time of performance of the polarizing plate.

A preferred range which is common in each of the sugar ester compounds which are used for the sugar ester compound mixture and a preferred range inherent in each of the sugar ester compounds satisfying the general formulae (I) to (III), respectively are hereunder described.

### (Properties Common in Respective Sugar Ester Compounds)

Each of the sugar ester compounds which are used for the sugar ester compound mixture has a monosaccharide residue or a disaccharide residue as a skeleton. That is, in the general formulae (I) to (III), each of G and G′ independently represents a monosaccharide residue or a disaccharide residue.

The sugar ester compound as referred to herein means a compound in which at least one group which can be substituted in the sugar skeleton structure constituting the subject compound (for example, a hydroxyl group or a carboxyl group) and at least one substituent are ester-bonded to each other. That is, in the sugar ester compound as referred to herein, sugar derivatives are also included in a broad sense, and for example, compounds containing a sugar residue such as gluconic acid as a structure are included, too. That is, in the sugar ester compound, esters between glucose and a carboxylic acid and esters between gluconic acid and an alcohol are included, too.

The sugar ester compound represented by each of the general formulae (I) to (III) which can be used in the invention is preferably a compound having a furanose structure or a pyranose structure. In the case of having a furanose structure or a pyranose structure as the sugar skeleton, in the general formulae (I) to (III), the conditions of (m+n)≧4, (p+q)≧4, and r≧4, and r≧3 can be satisfied.

Also, in the case of having a furanose structure or a pyranose structure as the sugar skeleton, the conditions that each of (m+n) and (p+q) is equal to a number of hydroxyl groups in the case of supposing that G is not a residue but an unsubstituted saccharide of a cyclic acetal structure of the same skeleton; and (r+t) is equal to a number of hydroxyl groups in the case of supposing that G′ is not a residue but an unsubstituted saccharide of a cyclic acetal structure of the same skeleton can be satisfied.

Incidentally, as an upper limit value of each of (m+n), (p+q), and (r+t), a value determined by the kind of G or G′ can be employed, and when G or G′ is a monosaccharide group, the upper limit is 5, whereas when G or G′ is a disaccharide residue, the upper limit is 8.

The sugar ester compound represented by each of the general formulae (I) to (III) is preferably an esterified compound in which in a compound (A) wherein G or G′ having one furanose structure or pyranose structure is a monosaccharide residue, or in a compound (B) wherein G or G′ having two of at least one kind of a furanose structure or a pyranose structure bonded thereto is a disaccharide residue, all or a part of OH groups are esterified.

However, the sugar ester compound mixture which is used in the invention is characterized by satisfying m>p and n<q in the general formulae (I) and (II), namely, at least in the sugar ester compound represented by the general formula (I), all of OH groups are not esterified. By using plural aromatic sugar ester compounds having a different ester substitution degree from each other in this way, not only volatility becomes low in the manufacturing step, but bleed-out from the cellulose ester film after the film formation hardly occurs.

Examples of the compound (A) include glucose, galactose, mannose, fructose, xylose, and arabinose. However, it should not be construed that the invention is limited thereto.

Examples of the compound (B) include lactose, sucrose, nystose, 1F-fructosyl nystose, stachyose, maltitol, lactitol, lactulose, cellobiose, maltose, cellotriose, maltotriose, raffinose, and kestose. In addition, there are exemplified gentiobiose, gentiotriose, gentiotetraose, xylotriose, and galactosyl-sucrose. However, it should not be construed that the invention is limited thereto.

Among these compound (A) and compound (B), compounds having both a furanose structure and a pyranose structure are preferable. As examples thereof, sucrose, kestose, nystose, 1F-fructosyl nystose, or stachyose is preferable, and sucrose is more preferable. Also, in the compound (B), a compound having two of at least one of a furanose structure and a pyranose structure bonded thereto is one of preferred embodiments.

The substituent which is used for esterifying all or a part of OH groups in the compound (A) or the compound (B) is not particularly limited. Above all, it is preferable to use a monocarboxylic acid. That is, it is preferable that each of R¹ in the general formula (I) and the general formula (II) and R² in the general formula (III) independently represents an acyl group.

The monocarboxylic acid is not particularly limited, and known aliphatic monocarboxylic acids, alicyclic monocarboxylic acids, aromatic monocarboxylic acids, and so on can be used. The carboxylic acid to be used may be used solely or in admixture of two or more kinds thereof. In the case where plural R¹s or plural R²s are present, each R¹, or each R², may be the same as or different from every other R¹ or R², respectively.

Meanwhile, it is preferable that each of L in the general formula (I) and the general formula (II) and L′ in the general formula (III) independently represents any one of —O—, —CO—, and —NR¹¹— (wherein R¹¹ represents a monovalent substituent); and in the case where plural Ls or plural L's are present, each L, or each L′, may be the same as or different from every other L or L′, respectively. Above all, from the viewpoint of the fact that each of R¹ and R² can be easily substituted with an acyl group, it is preferable that L or L′ represents —O—.

### (Mixture of Aromatic Sugar Ester Compounds Represented by the General Formulae (I) and (II))

Next, a preferred embodiment of the aromatic sugar ester compound represented by each of the general formulae (I) and (II) is described.

In each of the general formulae (I) and (II), each R¹ independently represents an aliphatic group or an aromatic group, and at least one R¹ represents an aromatic group. Above all, it is preferable that each R¹ independently represents only an aromatic group; and it is more preferable that all of R¹s represent the same aromatic group.

The invention is characterized in that the average ester substitution degree of each of the aromatic sugar ester compound represented by the general formula (I) and the aromatic sugar ester compound represented by the general formula (II) is less than 94%. In this way, when the average ester substitution degree of a mixture of two or more kinds of the aromatic sugar ester compounds is less than 94%, the resulting cellulose ester film can be conspicuously decreased in haze, and can be favorably used as an optical film for a polarizing plate or a liquid crystal display device.

From the viewpoint of the fact that when incorporated into a polarizing plate, a change with time of orthogonal transmittance in a wet heat atmosphere can be decreased, it is preferable that the average ester substitution degree of each of the aromatic sugar ester compound represented by the general formula (I) and the aromatic sugar ester compound represented by the general formula (II) is 62% or more and less than 94%.

Furthermore, from the viewpoint of the fact that when incorporated into a polarizing plate, a change with time of orthogonal transmittance in a wet heat atmosphere can be decreased, it is more preferable that not only G in each of the general formula (I) and the general formula (II) is a sucrose skeleton, but the average ester substitution degree of each of the aromatic sugar ester compound represented by the general formula (I) and the aromatic sugar ester compound represented by the general formula (II) is from 5 to 7.5. The average ester substitution degree is especially preferable from 5.5 to 7.0.

Also, in each of the general formulae (I) and (II), m represents an integer of 0 or more; and each of n, p, and q independently represents an integer of 1 or more, provided that m>p and n<q.

In the invention, in the case where G is a disaccharide residue, from the viewpoint of conspicuously decreasing the haze of the resulting cellulose ester film, it is preferable that an addition amount of the aromatic sugar ester represented by the general formula (II) wherein q is 8 is less than 20% by mass relative to a total addition amount of the aromatic sugar ester compound represented by the general formula (I) and the aromatic sugar ester compound represented by the general formula (II). In the case where G is a disaccharide group, a content of the aromatic sugar ester compound which does not have a hydroxyl group at all as the substituent is preferably not more than 20% by mass, more preferably not more than 15% by mass, especially preferably not more than 10% by mass, and more especially preferably not more than 5% by mass relative to the content of the whole of the aromatic sugar esters.

Meanwhile, in the invention, in the case where G is a disaccharide residue, in each of the aromatic sugar ester compound represented by the general formula (I) and the aromatic sugar ester compound represented by the general formula (II), it is preferable that n is 3 or more, and it is also preferable that n is 5 or more. That is, in the invention, it is preferable that the aromatic sugar ester compound which is at least contained in the aromatic sugar ester compound mixture is at least a tri-substituted or poly-substituted compound, and it is also preferable that the aromatic sugar ester compound is at least a penta-substituted or poly-substituted compound.

In the case where the aromatic sugar ester compound is a disaccharide, a content of from tri-substituted to penta-substituted compounds having from 3 to 5 esterified substituents is preferably from 10 to 70%, and more preferably 20 to 50% relative to the whole of the aromatic sugar ester compounds. A content of hexa-substituted to hepta-substituted compounds is preferably from 20 to 85%, and more preferably from 20 to 75% relative to the whole of the aromatic sugar ester compounds.

As preferred examples of the aromatic monocarboxylic acid which is used at the time of being substituted with R¹, there can be exemplified aromatic monocarboxylic acids obtained by introducing an alkyl group or an alkoxy group into a benzene ring of a benzoic acid such as benzoic acid and toluic acid; cinnamic acid; aromatic monocarboxylic acids having two or more benzene rings, such as benzilic acid, biphenylcarboxylic acid, naphthalenecarboxylic acid, and tetralincarboxylic acid; and derivatives thereof. More specifically, there can be exemplified xylylic acid, hemellitic acid, mesitylenic acid, prehnitylic acid, γ-isodurylic acid, durylic acid, mesitonic acid, α-isodurylic acid, cuminic acid, α-toluic acid, hydroatropic acid, atropic acid, hydrocinnamic acid, salicylic acid, o-anisic acid, m-anisic acid, p-anisic acid, creosote acid, o-homosalicylic acid, m-homosalicylic acid, p-homosalicylic acid, o-pyrocatechuic acid, β-resorcylic acid, vanillic acid, isovanillic acid, veratric acid, o-veratric acid, gallic acid, asarylic acid, mandelic acid, homoanisic acid, homovanillic acid, homoveratric acid, o-homoveratric acid, phthalonic acid, and p-coumaric acid. Of these, benzoic acid is especially preferable. That is, it is preferable that in each of the general formula (I) and the general formula (II), R¹ represents a benzoyl group.

A method of mixing a plurality of the aromatic sugar ester compounds having a different ester substitution degree from each other is not particularly limited, and a known method can be adopted. Also, for example, in the case of adopting a solution film formation method, the timing of mixing a plurality of the aromatic sugar ester compounds having a different ester substitution degree from each other may be one before addition to the cellulose ester dope, or one after individual addition of the plural sugar ester compounds to the cellulose ester dope.

### (Preferred Embodiment of Aliphatic Sugar Ester Compound)

Next, a preferred embodiment of the aliphatic sugar ester compound represented by the general formula (III) is described. In the general formula (III), each R² independently represents an aliphatic group.

As preferred examples of the aliphatic monocarboxylic acid which is used at the time of being substituted with R², there can be exemplified saturated fatty acids such as acetic acid, propionic acid, butyric acid, isobutyric acid, valeric acid, caproic acid, enanthic acid, caprylic acid, pelargonic acid, capric acid, 2-ethyl-hexanecarboxylic acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid, and lacceric acid; and unsaturated fatty acids such as undecylenic acid, oleic acid, sorbic acid, linolic acid, linoleic acid, arachidonic acid, and octenoic acid.

As preferred examples of the alicyclic monocarboxylic acid, there can be exemplified cyclopentanecarboxylic acid, cyclohexanecarboxylic acid, cyclooctanecarboxylic acid, and derivatives thereof.

It is preferable that each R² independently represents a non-cyclic aliphatic group; and it is more preferable that all of R²s represent a non-cyclic aliphatic group.

It is preferable that R² represents two or more kinds of aliphatic groups.

Of the aliphatic monocarboxylic acids, it is preferable that the aliphatic sugar compound represented by the general formula (III) is at least substituted with acetic acid. That is, it is preferable that at least one R² in the general formula (III) represents an acetyl group.

Meanwhile, it is more preferable that at least one R² represents a branched aliphatic group; and it is especially preferable that in the case where two or more R²s represent an aliphatic group, only one R² represents a branched aliphatic group. Above all, it is preferable that the aliphatic sugar ester represented by the general formula (III) is also substituted with isobutyric acid in addition to acetic acid. That is, it is preferable that R² in the general formula (III) contains an acetyl group and an isobutyryl group, and from the viewpoint of a change with time of optical performance, it is preferable that R² contains only an acetyl group and an isobutyryl group.

From the viewpoints of not only improving planar failure of the resulting cellulose ester film but improving durability of the polarizing plate, it is preferable that G′ in the general formula (III) represents a disaccharide residue.

In the case where R² in the general formula (III) is composed of only an acetyl group and an isobutyryl group, for example, when G′ is a disaccharide residue, a ratio of the acetyl group to the isobutyryl group is preferably from 1/7 to 4/4, more preferably from 1/7 to 3/5, and especially preferably 2/6.

A manufacturing method of an aliphatic sugar ester compound substituted with such an aliphatic monocarboxylic acid is described in, for example, JP-A-8-245678.

An example of the manufacturing method of the esterified compound is as follows.

Acetic anhydride (200 mL) was added dropwise to a solution having pyridine (100 mL) added to glucose (29.8 g, 166 mmoles), and the mixture was allowed to react for 24 hours. Thereafter, the resulting solution was concentrated by means of evaporation and then poured into water with ice. After allowing the resulting solution to stand for one hour, a solid was separated from water by means of filtration with a glass filter. The solid on the glass filter was dissolved in chloroform and subjected to liquid separation with cold water until the system became neutral. An organic phase was separated and then dried over anhydrous sodium sulfate. After removing the anhydrous sodium sulfate by means of filtration, the chloroform was removed by means of evaporation, and the residue was further dried under reduced pressure to obtain glucose pentaacetate (58.8 g, 150 mmoles, yield: 90.9%). In this connection, the foregoing monocarboxylic acid can be used in place of the acetic anhydride.

Specific examples of the sugar ester compounds represented by the general formulae (I) to (III), which can be used in the invention, are given below, but it should not be construed that the invention is limited thereto. Also, though the ester substitution degree of each of the sugar ester compounds is not described in the following specific examples, a sugar ester compound mixture can be formed by using sugar ester compounds having an arbitrary ester substitution degree so far as the gist of the invention is not deviated. In particular, as for the aromatic sugar ester compounds represented by the general formulae (I) and (H), an arbitrary combination satisfying the requirements of the invention can be chosen and used.

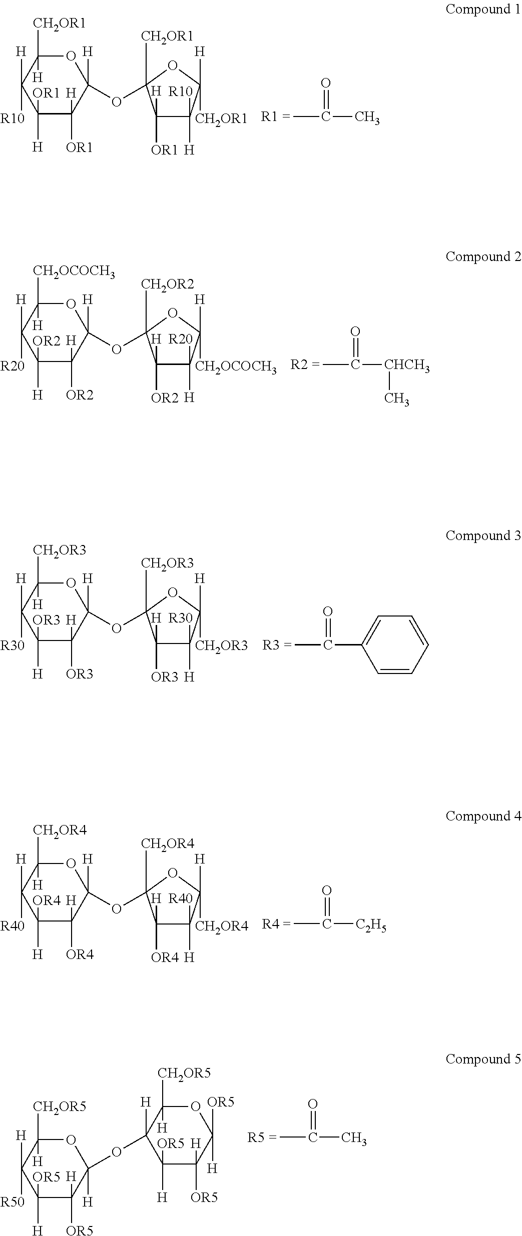

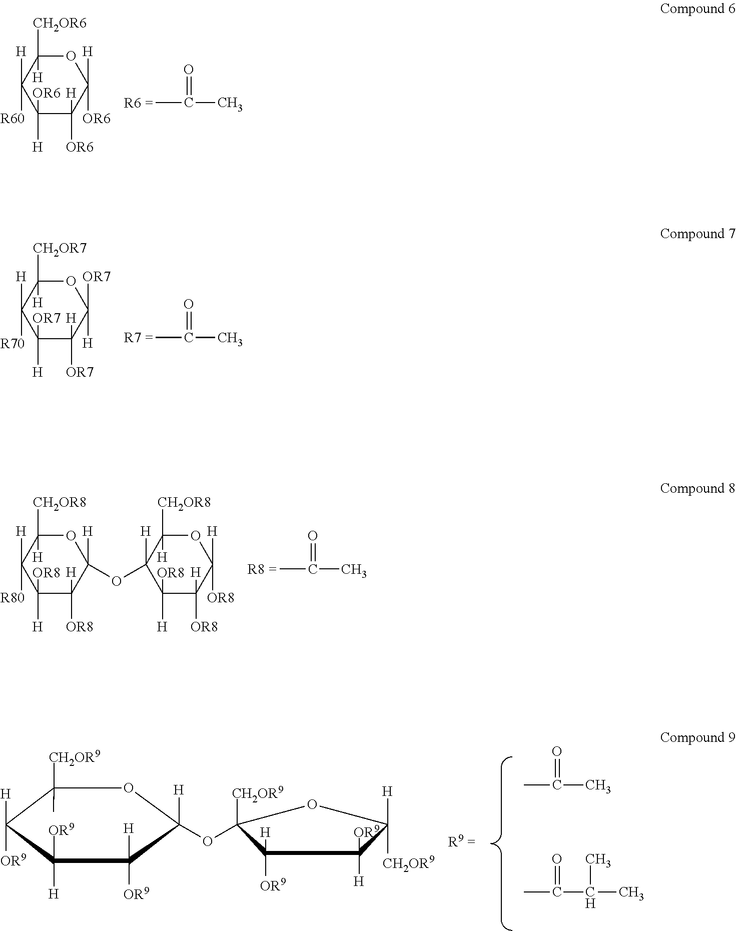

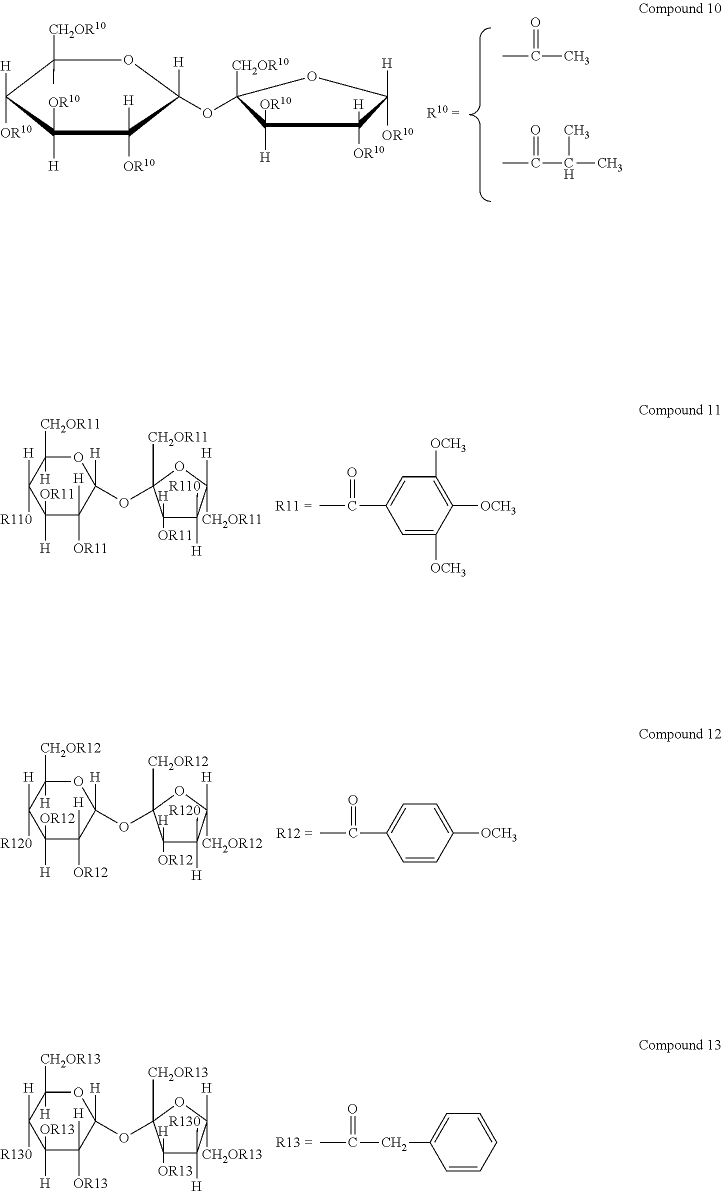

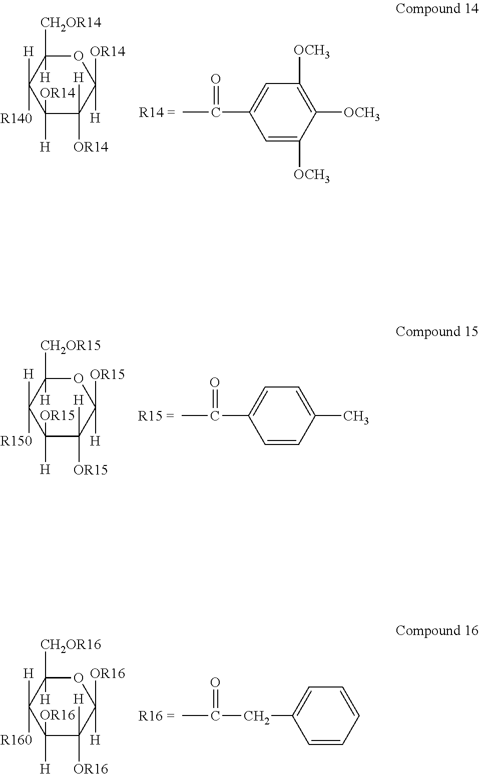

In the following structural formulae, each R independently represents an arbitrary substituent, and each R may be the same as or different from every other R.

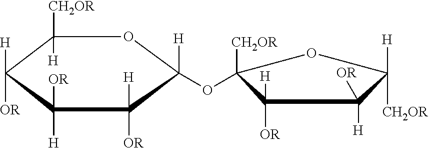

| | Substituent 1 | | Substituent 2 | | |
|---|---|---|---|---|---|
| | | Substitution | Kind | Substitution | Molecular |
| Compound | Kind | degree | | degree | weight |
| 101 | Acetyl | 7 | Benzyl | 1 | 727 |
| 102 | Acetyl | 6 | Benzyl | 2 | 775 |
| 103 | Acetyl | 7 | Benzoyl | 1 | 741 |
| 104 | Acetyl | 6 | Benzoyl | 2 | 802 |
| 105 | Benzyl | 2 | No | 0 | 523 |
| 106 | Benzyl | 3 | No | 0 | 613 |
| 107 | Benzyl | 4 | No | 0 | 702 |
| 108 | Acetyl | 7 | Phenyl | 1 | 771 |
| | | | Acetyl | | |
| 109 | Acetyl | 6 | Phenyl | 2 | 847 |
| | | | Acetyl | | |
| 110 | Benzoyl | 1 | No | — | 446 |
| 111 | Benzoyl | 2 | No | — | 550 |
| 112 | Benzoyl | 3 | No | — | 654 |
| 113 | Benzoyl | 4 | No | — | 758 |
| 114 | Benzoyl | 5 | No | — | 862 |
| 115 | Benzoyl | 6 | No | — | 966 |
| 116 | Benzoyl | 7 | No | — | 1070 |
| 117 | Benzoyl | 8 | No | — | 1174 |

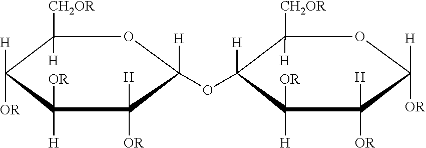

| | Substituent 1 | | Substituent 2 | | |
|---|---|---|---|---|---|
| | | Substitution | | Substitution | Molecular |
| Compound | Kind | degree | Kind | degree | weight |
| 301 | Acetyl | 6 | Benzoyl | 2 | 803 |
| 302 | Acetyl | 6 | Benzyl | 2 | 775 |
| 303 | Acetyl | 6 | Phenyl | 2 | 831 |
| | | | Acetyl | | |
| 304 | Benzoyl | 2 | No | 0 | 551 |
| 305 | Benzyl | 2 | No | 0 | 522 |
| 306 | Phenyl | 2 | No | 0 | 579 |
| | Acetyl | | | | |

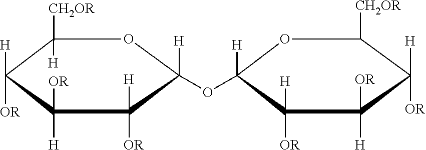

| | Substituent 1 | | Substituent 2 | | |
|---|---|---|---|---|---|
| | | Substitution | | Substitution | Molecular |
| Compound | Kind | degree | Kind | degree | weight |
| 401 | Acetyl | 6 | Benzoyl | 2 | 803 |
| 402 | Acetyl | 6 | Benzyl | 2 | 775 |
| 403 | Acetyl | 6 | Phenyl | 2 | 831 |
| | | | Acetyl | | |
| 404 | Benzoyl | 2 | No | 0 | 551 |
| 405 | Benzyl | 2 | No | 0 | 523 |
| 406 | Phenyl | 2 | No | 0 | 579 |
| | Acetyl | | | | |

### (Mixing of Aromatic Sugar Ester Compound and Aliphatic Sugar Ester Compound)

By adding a mixture of a plurality of the aromatic sugar ester compounds satisfying the foregoing requirements and having a different ester substitution degree from each other and the aliphatic sugar ester compounds to a cellulose ester film, durability of an optical performance of the film and durability of the polarizing plate in a wet heat atmosphere can be more improved as compared with the case of a mixture of only aromatic sugar ester compounds having a different ester substitution degree from each other. Incidentally, as a matter of course, durability of an optical performance of the film and durability of the polarizing plate can also be improved with regards to a known phosphoric acid ester based plasticizer such as so-called TPP/BDP. Also, in the case of being stacked with a hard coat layer, a film which is excellent in adhesion and good in pencil hardness is obtainable, too.

The cellulose ester film in the invention contains the aromatic sugar ester compounds represented by the general formulae (I) and (II) in a total amount of preferably from 1 to 30% by mass, more preferably from 5 to 20% by mass, and especially preferably from 5 to 15% by mass relative to the cellulose ester.

The cellulose ester film in the invention contains the aliphatic sugar ester compound represented by the general formula (III) in an amount of preferably from 1 to 30% by mass, more preferably from 1 to 10% by mass, and especially preferably from 1 to 5% by mass relative to the cellulose ester.

A mixing ratio of the aromatic sugar ester compounds represented by the general formulae (I) and (II) and the aliphatic sugar ester compound represented by the general formula (III) is not particularly limited. Above all, a ratio of the addition amount of the aromatic sugar ester compounds to the addition amount of the aliphatic ester compound (mass ratio) is preferably more than 1, more preferably from 2 to 10, and especially preferably from 3 to 5.

The cellulose ester film in the invention contains the sugar ester compounds represented by the general formulae (I) to (III) in a total amount of preferably from 1 to 30% by mass, more preferably from 5 to 30% by mass, especially preferably from 5 to 20% by mass, and more especially preferably from 5 to 15% by mass. What the total amount of the sugar ester compounds represented by the general formulae (I) to (III) falls within the foregoing range is preferable because bleed-out or the like does not occur.

Also, in the case where a polycondensed ester plasticizer as described later is used in combination with the sugar ester compounds, an addition amount (part by mass) of the sugar ester compounds to an addition amount (part by mass) of the polycondensed ester plasticizer is preferably from 2 to 10 times (mass ratio), and more preferably from 3 to 8 times (mass ratio).

Also, in the case where a compound having at least two aromatic rings as described later is used in combination with the sugar ester compounds, an addition amount (part by mass) of the sugar ester compounds to an addition amount (part by mass) of the compound having at least two aromatic rings is preferably from 2 to 10 times (mass ratio), and more preferably from 3 to 8 times (mass ratio).

Also, for example, in the case of adopting a solution film formation method, the timing of mixing a plurality of the aromatic sugar ester compounds and the aliphatic sugar ester compound may be one before addition to the cellulose ester dope, or one after individual addition of the plural sugar ester compounds to the cellulose ester dope.

### <Polycondensed Ester>

The film of the invention may contain a polycondensed ester (hereinafter also referred to as “oligomer plasticizer”) so far as the gist of the invention is not deviated.

The polycondensed ester can be obtained by using, as a raw material, a mixture containing at least one aromatic dicarboxylic acid (aromatic ring-containing dicarboxylic acid), at least one aliphatic dicarboxylic acid, at least one aliphatic diol, and at least monocarboxylic acid.

Preferred examples of the oligomer plasticizer include polycondensed esters of a diol component and a dicarboxylic acid component and derivative thereof; and oligomers of methyl acrylate (MA) and derivatives thereof (hereinafter also referred to as “MA oligomer plasticizer”).

The polycondensed ester is a polycondensed ester of a dicarboxylic acid component and a diol component. The dicarboxylic acid component may be composed of only a single dicarboxylic acid or may be a mixture of two or more kinds of dicarboxylic acids. Above all, it is preferable to use, as the dicarboxylic acid component, a dicarboxylic acid component containing at least one aromatic dicarboxylic acid and at least one aliphatic dicarboxylic acid. Meanwhile, the diol component may also be composed of only a single diol component or may be a mixture of two or more kinds of diols. Above all, it is preferable to use, as the diol component, ethylene glycol and/or an aliphatic diol having an average carbon atom number of more than 2.0 and not more than 3.0.

As the polycondensed ester, compounds described in paragraphs [0029] to [0045] of JP-A-2010-079241 can be preferably used.

### <Compound Having at Least Two Aromatic Rings>

The cellulose ester film of the invention may further contain a compound having at least two aromatic rings so far as the gist of the invention is not deviated.

The compound having at least two aromatic rings is hereunder described.

It is preferable that when uniformly aligned, the compound having at least two aromatic rings reveals optically positive uniaxiality.

A molecular weight of the compound having at least two aromatic rings is preferably from 300 to 1,200, and more preferably from 400 to 1,000.

In the case where the cellulose ester film in the invention is used as an optically compensatory film, in order to control optical characteristics, in particular Re to preferred values, stretching is effective. For the purpose of raising the Re, it is necessary to increase the refractive index anisotropy within the film plane, and one method thereof is to enhance the alignment of a principal chain of the polymer film by stretching. Also, by using a compound with large refractive index anisotropy, it is possible to further raise the refractive index anisotropy of the film. For example, in the compound having at least two aromatic rings, when a force by which the polymer principal chain is arranged conducts due to stretching, alignment properties of the compound are enhanced, whereby it becomes easy to control the film so as to have the desired optical characteristics.

Examples of the compound having at least two aromatic rings include triazine compounds described in JP-A-2003-344655; rod-shaped compounds described in JP-A-2002-363343; and liquid crystalline compounds described in JP-A-2005-134884 and JP-A-2007-119737. Of these, the triazine compounds or rod-shaped compounds are more preferable.

The compound having at least two aromatic rings can also be used in combination of two or more kinds thereof.

### [Organic Solvent of Cellulose Acylate Solution]

In the invention, it is preferable to manufacture the cellulose acylate film by a solvent casting method, and the film is manufactured by using a solution (dope) having the cellulose acylate dissolved in an organic solvent. The organic solvent which is preferably used as a prime solvent of the invention is preferably a solvent selected among esters having from 3 to 12 carbon atoms, ketones having from 3 to 12 carbon atoms, ethers having from 3 to 12 carbon atoms, and halogenated hydrocarbons having from 1 to 7 carbon atoms. Each of the esters, ketones and ethers may have a cyclic structure. Compounds having any two or more of ester, ketone and ether functional groups (namely, —O—, —CO—, and —COO—) can also be used as the prime solvent, and for example, may have other functional group such as an alcoholic hydroxyl group.

For the cellulose acylate film in the invention, a chlorine based halogenated hydrocarbon may be used as the prime solvent, and a non-chlorine based solvent may also be used as the prime solvent as described in Journal of Technical Disclosure, No. 2001-1745, pages 12 to 16 (issued on Mar. 15, 2001 by Japan Institute of Invention and Innovation). There is no particular limitation for the cellulose acylate film of the invention.

Besides, the solvent for the cellulose acylate solution and the film in the invention including a dissolution method thereof are disclosed in the following patent documents and are preferred embodiments. Those patent documents include JP-A-2000-95876, JP-A-12-95877, JP-A-10-324774, JP-A-8-152514, JP-A-10-330538, JP-A-9-95538, JP-A-9-95557, JP-A-10-235664, JP-A-12-63534, JP-A-11-21379, JP-A-10-182853, JP-A-10-278056, JP-A-10-279702, JP-A-10-323853, JP-A-10-237186, JP-A-11-60807, JP-A-11-152342, JP-A-11-292988, JP-A-11-60752, and JP-A-11-60752. These patent documents describe not only solvents which are preferable for the cellulose acylate in the invention but their solution physical properties and coexistent materials to be made to coexist, and these are also preferred embodiments in the invention.

### [Manufacturing Step of Cellulose Acylate Film]

### [Dissolution Step]

The preparation of the cellulose acylate solution (dope) in the invention is not particularly limited with respect to its dissolution method, and it may be carried out at room temperature or by means of cooling dissolution or high-temperature dissolution or a combination thereof. With respect to the preparation of the cellulose acylate solution in the invention and respective steps following the dissolution step, such as solution concentration and filtration, the manufacturing steps described in detail in Journal of Technical Disclosure, No. 2001-1745, pages 22 to 25, issued on Mar. 15, 2001 by Japan Institute of Invention and Innovation are preferably adopted.

### [Casting, Drying and Winding Steps]

Next, the manufacturing method of a film using the cellulose acylate solution in the invention is described. As a method and equipment for manufacturing the cellulose acylate film in the invention, a solution casting film formation method and a solution casting film formation apparatus which have been conventionally provided for the manufacture of a cellulose triacetate film are adopted. A dope (cellulose acylate solution) prepared in a dissolution machine (pot) is once stored in a storage pot, and after defoaming of bubbles contained in the dope, the dope is subjected to final preparation. Then, the dope is discharged from a dope exhaust and fed into a pressure die via, for example, a pressure constant-rate gear pump capable of feeding the dope at a constant flow rate at a high accuracy depending upon a rotational rate; the dope is uniformly cast from a nozzle (slit) of the pressure die onto a metallic support continuously running in an endless manner in the casting section; and at the peeling point where the metallic support has substantially rounded in one cycle, the half-dried dope film (also called a web) is peeled away from the metallic support. The obtained web is clipped at both ends and dried by conveying with a tenter while keeping a width. Subsequently, the resulting film is mechanically conveyed with a group of rolls in a dryer to terminate the drying and then wound in a roll form with a winder in a prescribed length. A combination of the tenter and the dryer of a group of rolls varies depending upon the purpose. As another embodiment, there can be adopted a variety of methods for film formation by a solvent casting method, such as a method in which a drum cooled to not higher than 0° C. is used as the foregoing metallic support, a dope cast from a die is gelled on the drum, and at a point of time when it has substantially rounded in one cycle, the gelled dope is peeled away and conveyed and dried by a pin-shaped tenter while stretching.

In the solution casting film formation method to be used for a functional polarizing plate protective film that is an optical member for electronic display, or a silver halide photographic material, both of which are a main application of the cellulose acylate film in the invention, in addition to a solution casting film forming apparatus, a coating apparatus is frequently added for the surface processing onto a film such as a subbing layer, an antistatic layer, an anti-halation layer, and a protective layer. These are described in detail in Journal of Technical Disclosure, No. 2001-1745, pages 25 to 30, issued on Mar. 15, 2001 by Japan Institute of Invention and Innovation and are classified into casting (including co-casting), metallic support, drying, peeling, and so on. These can be preferably adopted in the invention.

### [Thickness of Film]

Also, a thickness of the cellulose acylate film is preferably from 20 to 120 μm, more preferably from 30 to 90 μm, and especially preferably from 35 to 80 μm. Also, in the case of being used as protective film for polarizer to be stuck to a liquid crystal panel, what the thickness of the cellulose acylate film is from 30 to 65 μm is especially preferable because warp to be caused following a change in temperature and relative humidity is small.

### [Physical Properties of Hard Coat Layer]

A refractive index of the hard coat layer formed from the hard coat layer forming composition is preferably in the range of from 1.45 or more and not more than 1.55, more preferably from 1.46 or more and not more than 1.54, and still more preferably 1.48 or more and not more than 1.54 from the standpoint of optical design for the purposes of suppressing interference unevenness and obtaining antireflection performance.

From the viewpoint of imparting sufficient durability and impact resistance to the film, a film thickness of the hard coat layer is from 0.5 μm to 20 μm, preferably from 1 μm to 10 μm, and more preferably from 1 μm to 5 μm. Here, the film thickness of the hard coat layer does not include a thickness of a gradation region as described later.

Also, a strength of the hard coat layer is preferably H or more, more preferably 2H or more, and most preferably 3H or more by a pencil hardness test. Furthermore, it is preferable that an abrasion amount of a specimen before and after the test is small as far as possible in a taber test in conformity with JIS K5400.

### [Antireflection Layer]

### (Low Refractive Index Layer)

It is preferable that the optical film of the invention has an antireflection layer (for example, a low refractive index layer) on the hard coat layer directly or via other layer. In that case, the optical film of the invention can function as an antireflection film.

In the case of providing a low refractive index layer directly on the hard coat layer, it is preferable that the low refractive index layer is a thin film layer having a layer thickness of not more than 200 nm. Furthermore, the low refractive index layer may be formed in a layer thickness of about ¼ of a designed wavelength in terms of an optical layer thickness. However, in the case of a single-layer thin film interference type which inhibits reflection by a low refractive index layer of the simplest structure formed of one layer, any low refractive index material suitable for practical use, which can satisfy a reflectance of not more than 0.5% and has neutral tint, high resistance to scuffing, chemical resistance, and weather resistance, is not available yet. Therefore, in the case of requiring lower reflection, there may be adopted antireflection films of a multilayered thin film interference type for preventing reflection by optical interference of multiple layers, such as a two-layer thin film interference type in which a high refractive index layer is formed between a hard coat layer and a low refractive index layer; and a three-layer thin film interference type in which a middle refractive index layer and a high refractive index layer are successively formed between a hard coat layer and a low refractive index layer.

In that case, a refractive index of the low refractive index layer is preferably from 1.30 to 1.51, more preferably from 1.30 to 1.46, and still more preferably from 1.32 to 1.38. What the refractive index of the low refractive index layer is made to fall within the foregoing range is preferable because the refractive index is suppressed, and the film strength can be kept. As to a method for forming the low refractive index layer, a transparent thin film of an inorganic oxide can be used by means of a chemical vapor deposition (CVD) method or a physical vapor deposition (PVD) method, and in particular, a vacuum vapor deposition method or a sputtering method, each of which is one kind of the physical vapor deposition methods. However, it is preferable to adopt a method by all-wet coating using a composition for low refractive index layer.

The low refractive index layer is not particularly limited so far as it is a layer having a refractive index falling within the foregoing range. However, known materials can be used as constituent components. Specifically, a composition containing a fluorine-containing curable resin and an inorganic fine particle as described in JP-A-2007-298974 and hollow silica fine particle-containing low refractive index coatings described in JP-A-2002-317152, JP-A-2003-202406, and JP-A-2003-292831 can be suitably used.

### (High Refractive Index Layer and Middle Refractive Index Layer)

A refractive index of the high refractive index layer is preferably from 1.65 to 2.20, and more preferably from 1.70 to 1.80. The refractive index of the middle refractive index layer is adjusted such that it is a value between the refractive index of the low refractive index layer and the refractive index of the high refractive index layer. The refractive index of the middle refractive index layer is more preferably from 1.55 to 1.65, and still more preferably from 1.58 to 1.63.

As to a method for forming each of the high refractive index layer and the middle refractive index layer, a transparent thin film of an inorganic oxide can be used by means of a chemical vapor deposition (CVD) method or a physical vapor deposition (PVD) method, and in particular, a vacuum vapor deposition method or a sputtering method, each of which is one kind of the physical vapor deposition methods. However, it is preferable to adopt a method by all-wet coating using a composition for low refractive index layer.

Each of the middle refractive index layer and the high refractive index layer is not particularly limited so far as it is a layer having a refractive index falling within the foregoing range. However, known materials can be used as constituent components. Specifically, those described in paragraphs [0074] to [0094] of JP-A-2008-262187 are useful.

### (Gradation Region)

In the optical film of the invention, a gradation region where the compound distribution (the base material component and the hard coat layer component) gradually changes from the transparent base material side toward the hard coat layer side is present between the transparent base material and the hard coat layer.

The hard coat layer as referred to herein means a portion containing only the hard coat layer component but not containing the base material component, and the base material as referred to herein means a portion not containing the hard coat layer component.

From the viewpoint of suppressing interference unevenness, a thickness of the gradation region is preferably 5% or more and not more than 200%, more preferably 5% or more and not more than 150%, and most preferably 5% or more and not more than 95% relative to the thickness of the hard coat layer.

The reason why the foregoing region is preferable resides in the matter that when the gradation region can be formed in a thin thickness as far as possible, the thickness of the hard coat layer becomes thick in proportion, and hence, favorable hard coat properties (high hardness and low curl) are easily kept.

### (Manufacturing Method of Optical Film)

The optical film of the invention can be formed in the following method, but it should not be construed that the invention is limited to this method.

First of all, a hard coat layer forming composition is prepared. Subsequently, the composition is coated on a transparent support by means of a dip coating method, an air knife coating method, a curtain coating method, a roller coating method, a wire bar coating method, a gravure coating method, a die coating method, or the like, followed by heating and drying. Above all, a microgravure coating method, a wire bar coating method, or a die coating process (see U.S. Pat. No. 2,681,294 and JP-A-2006-122889) are more preferable, with a die coating method being especially preferable.

After coating, the resultant is dried and irradiated with light to cure the layer made of the hard coat layer forming composition, thereby forming a hard coat layer. If desired, after previously coating other layers on the transparent base material, the hard coat layer can be formed thereon. In this way, the optical film of the invention is obtained. Also, if desired, other layers as described previously can be provided. In the manufacturing method of an optical film of the invention, plural layers may be coated simultaneously or successively.

[Optical Film with Low PV Value]

The invention is concerned with an optical film including a clear hard coat layer (having a haze of not more than 1.0%) on a transparent base material, in which a peak intensity PV value obtained by subjecting a reflectance spectrum by an optical interference method to a Fourier transform is from 0.000 to 0.006. The PV value is preferably from 0.000 to 0.003.

First of all, the PV value is described.

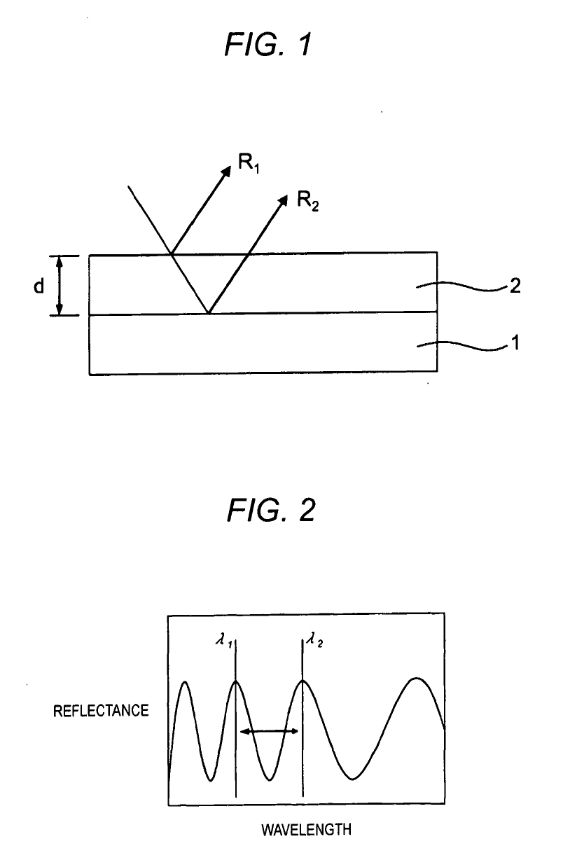

As shown in FIG. 1, when a film 2 (film thickness: d) coated on a substrate 1 is taken as an example, light which has been made incident in an upper portion of an objective sample reflects on the surface of the film 2 (R1), and light which has transmitted through the film further reflects at an interface between the substrate 1 and the film 2 (R2). At that time, a reflectance spectrum shown in FIG. 2 is obtained due to light interference to be caused due to a deviation of phase by an optical path difference. The positions and numbers of peaks and valleys of such a reflectance spectrum depend upon a wavelength of the incident light, a refractive index n of the film, and a film thickness d, and hence, the thickness of the film can be computed from peak wavelengths and valley wavelengths. For example, the film thickness can be computed from a gap between two peak wavelengths λ₁ and λ₂. When the reflectance is small, and influences of a noise are large, there may be the case where it is difficult to detect peaks and valleys from the reflectance spectrum, so that a correct film thickness is not obtainable. When a Fourier transform is applied to such a reflectance spectrum, the detection can be carried out without being substantially influenced by a noise, and the film thickness of a multilayered film can also be analyzed. Specifically, when a reflectance spectrum is subjected to a Fourier transform, and its power spectrum is reviewed, the spectrum is converted into a spectrum having peaks at positions corresponding to optical film thickness values (refractive index×film thickness: nd), respectively; and by reading values of the peak value, the thickness of the corresponding film can be known. In the case of a multilayered film, a spectrum having a product of the refractive index and the film thickness of each thin film layer, namely a period derived from an optical film thickness, is revealed, so that it becomes possible to extract the optical film thickness of each layer.

The PV value is a value expressing a size of reflection at the interface and means a peak intensity of a powder spectrum obtained by subjecting variations derived from thin film interference of the reflectance spectrum as described previously to a Fourier transform. When a difference in refractive index at the interface is small, the intensity is small; whereas when a difference in refractive index at the interface is large, the intensity is large.

In the invention, a larger value of the peak intensities corresponding to the two interfaces between the transparent base material and the gradation layer and between the gradation layer and the hard coat layer in the power spectrum is defined as the PV value and employed as an index of the interference unevenness. It is meant that the smaller this value, the more suppressed the interference unevenness is. Also, in fact, even when values of the PV value are identical, it is known that in the case where the PV value is detected at both of the two interfaces, a level of the interference unevenness is worse as compared with the case where the PV value is detected at only one interface. This is because the latter is approximately twice the former in terms of an amount of interfacial reflection.

In the optical film having a PV value of from 0.000 to 0.006, as the transparent base material, those described previously can be used. Also, the clear hard coat layer as referred to herein means a hard coat layer having a haze of not more than 1%, and for example, it can be formed of the foregoing hard coat layer forming composition.

The optical film having a PV value of from 0.000 to 0.006 can also be fabricated by the following means (1) or (2).

(1) A refractive index of the hard coat layer is made close to a refractive index of the transparent base material, thereby reducing an absolute value in difference of refractive index between the base material and the hard coat layer. The hard coat layer is formed using a solvent having dissolving ability against the transparent base material. As a method of reducing an absolute value in difference of refractive index between the base material and the hard coat layer, there are exemplified a method of using a raw material having a refractive index close to that of the base material for the hard coat layer; and a method of adjusting a degree of curing of the hard coat layer.
(2) A solvent having dissolving ability and swelling ability against the transparent base material is used for the hard coat layer forming composition, thereby adjusting diffusion of a curable compound (monomer) into the transparent base material by an interference condition. For example, there is exemplified a method of applying a heater from a rear side of the transparent base material, thereby accelerating diffusion of the monomer into the base material, or delaying a drying rate.

### [Protective Film for Polarizing Plate]

In the case of using the optical film as a surface protective film of a polarizing film (protective film for polarizing plate), adhesion to the polarizing film composed mainly of polyvinyl alcohol can be improved by a so-called saponification treatment for hydrophilizing the surface of a transparent support on the opposite side to the side having a thin film layer, namely the surface on the side to be stuck to the polarizing film.

It is also preferable that of two protective films of a polarizer, the film other than the optical film is an optically compensatory film having an optically compensatory layer including an optically anisotropic layer. The optically compensatory film (retardation film) is able to improve viewing angle characteristics of a liquid crystal display screen.

As the optically compensatory film, known materials can be used. From the standpoint of widening a viewing angle, optically compensatory films described in JP-A-2001-100042 are preferable.

The foregoing saponification treatment is described. The saponification treatment is a treatment of dipping an optical film in a heated alkaline aqueous solution for a certain period of time and washing it with water, followed by washing with an acid for achieving neutralization. So far as the surface on the side to be stuck to the polarizing film of the transparent support can be made hydrophilic, any treatment condition may be adopted, and hence, a concentration of the treating agent, a temperature of the treating agent liquid, and a treatment time are properly determined. However, in general, from the standpoint of necessity of ensuring productivity, a treatment condition is determined in such a manner that the treatment can be achieved within 3 minutes. As a general condition, the alkali concentration is from 3% by mass to 25% by mass; the treatment temperature is from 30° C. to 70° C.; and the treatment time is from 15 seconds to 5 minutes. As the alkali species to be used for the alkali treatment, sodium hydroxide or potassium hydroxide is suitable; as the acid to be used for washing with an acid, sulfuric acid is suitable; and as water to be used for washing with water, ion exchanged water or pure water is suitable.

In the antistatic layer of the optical film of the invention, even when exposed to the alkaline aqueous solution by such a saponification treatment, its antistatic performance is kept favorable.

In the case of using the optical film of the invention as a surface protective film for polarizing film (protective film for polarizing plate), the cellulose acylate film is preferably a cellulose triacetate film.

### [Polarizing Plate]

Next, the polarizing plate of the invention is described.

The polarizing plate of the invention is a polarizing plate having a polarizing film and two protective films for protecting the both surfaces of the polarizing film, which is characterized in that at least one of the protective films is the optical film or antireflection film of the invention.

The polarizing film is an iodine based polarizing film, a dye based polarizing film using a dichroic dye, or a polyene based polarizing film. The iodine based polarizing film and the dye based polarizing film can be in general manufactured by using a polyvinyl alcohol based film.

A configuration in which the cellulose acylate film of the optical film is bonded to the polarizing film optionally via an adhesive layer composed of polyvinyl alcohol, and the protective film is also provided on the other side of the polarizing film is preferable. An adhesive layer may also be provided on the surface of the protective film on the opposite side to the polarizing film.

By using the optical film of the invention as a protective film for polarizing plate, a polarizing plate having excellent physical strength, antistatic properties and durability can be fabricated.

Also, the polarizing plate of the invention can have an optically compensatory function. In that case, it is preferable that only one side of any of the front surface and the back surface of the two surface protective films is formed using the foregoing optical film, whereas the surface protective film on the other side of the polarizing plate against the side on which the optical film is provided is an optically compensatory film.

By fabricating a polarizing plate using the optical film of the invention for one of the protective films for polarizing plate and an optically compensatory film having optical anisotropy for the other protective film of the polarizing film, respectively, it is possible to further improve contrast in a bright room and a viewing angle in the up and down, left and right directions of a liquid crystal display device.

### [Image Display Device]

The image display device of the invention has the optical film, antireflection film or polarizing plate of the invention on the superficial surface of the display.

The optical film, antireflection film or polarizing plate of the invention can be suitably used for image display devices such as a liquid crystal display device (LCD), a plasma display panel (PDP), an electroluminescence display (ELD), and a cathode ray tube display device (CRT).

In particular, the optical film, antireflection film or polarizing plate of the invention can be advantageously used for image display devices such as a liquid crystal display device; and it is especially preferable to use it for a superficial layer on the side of a backlight of a liquid crystal cell in a transmission or semi-transmission liquid crystal display device.

In general, the liquid crystal display device includes a liquid crystal cell and two polarizing plates disposed on the both sides thereof; and the liquid crystal cell carries a liquid crystal between two electrode substrates. Furthermore, one optically anisotropic layer is disposed between the liquid crystal cell and the polarizing plate of one side, or two optically anisotropic layers may be disposed between the liquid crystal cell and each of the both polarizing plates.

The liquid crystal cell is preferably of a TN mode, a VA mode, an OCB mode, an IPS mode, or an ECB mode.

### EXAMPLES

The invention is more specifically described below with reference to the following Examples, but it should not be construed that the scope of the invention is limited thereto. Incidentally, all “parts” and “%” are on a mass basis unless otherwise indicated.

### Example 1

### Fabrication of Optical Film

A coating liquid for forming each layer was prepared to form each layer as shown below, thereby fabricating optical film samples 1 to 13.

### (Preparation of Coating Liquid for Hard Coat Layer)

The following composition was charged in a mixing tank and stirred, followed by filtration with a polypropylene-made filter having a pore size of 0.4 μm, thereby preparing a coating liquid A-1 for hard coat layer (solids concentration: 58% by mass).

| | |
|---|---|
| Solvent (described in Table 1) | 21.0 parts by mass |
| | (total amount in the case |
| | of two or more kinds) |
| Monomer (a): PET30 | 22.52 parts by mass |
| Monomer (b): Urethane monomer | 6.30 parts by mass |
| Photopolymerization initiator (Irgacure 184, | 0.84 parts by mass |
| manufactured by Ciba Specialty Chemicals) | |
| Leveling agent (SP-13) | 0.006 parts by mass |

In a similar manner to that in the coating liquid A-1 for hard coat layer, respective components were mixed as shown in the following Table 1 and dissolved in a solvent so as to have a ratio shown in Table 1, thereby preparing coating liquids A-2 to A-14 for hard coat layer.

TABLE 1

| | Monomer (a) | | | | | Monomer (b) | | | | |
|---|---|---|---|---|---|---|---|---|---|---|
| | | Addition amount | | | | | Addition amount | | | |
| | | (% by mass) | | | | | (% by mass) | | | |
| | | (proportion to | | | Functional | | (proportion to | | | Functional |
| Coating | | the total sum of | SP | | group | | the total sum of | SP | | group |
| liquid | Kind | (a) and (b)) | value | Mw | number | Kind | (a) and (b)) | value | Mw | number |
| A-1 | PET30 | 80 | 21.6 | 298 | 3.4 | Urethane | 20 | 22.3 | 596 | 4 |
| | | | | | | monomer | | | | |
| A-2 | PET30 | 50 | 21.6 | 298 | 3.4 | Urethane | 50 | 22.3 | 596 | 4 |
| | | | | | | monomer | | | | |
| A-3 | PET30 | 80 | 21.6 | 298 | 3.4 | EB5129 | 20 | 22.1 | 765 | 6 |
| A-4 | — | — | — | — | — | Urethane | 100 | 22.3 | 596 | 4 |
| | | | | | | monomer | | | | |
| A-5 | PET30 | 35 | 21.6 | 298 | 3.4 | Urethane | 65 | 22.3 | 596 | 4 |
| | | | | | | monomer | | | | |
| A-6 | PET30 | 10 | 21.6 | 298 | 3.4 | Urethane | 90 | 22.3 | 596 | 4 |
| | | | | | | monomer | | | | |
| A-7 | DPCA-30 | 10 | 20.1 | 921 | 6 | Urethane | 90 | 22.3 | 596 | 4 |
| | | | | | | monomer | | | | |
| A-8 | A-9300 | 10 | 26.0 | 423 | 3 | Urethane | 90 | 22.3 | 596 | 4 |
| | | | | | | monomer | | | | |
| A-9 | DPCA-120 | 10 | 19.8 | 1947 | 6 | Urethane | 90 | 22.3 | 596 | 4 |
| | | | | | | monomer | | | | |
| A-10 | PET30 | 100 | 21.6 | 298 | 3.4 | — | — | — | — | — |
| A-11 | PET30 | 35 | 21.6 | 298 | 3.4 | DPCA-120 | 65 | 19.8 | 1947 | 6 |
| A-12 | PET30 | 80 | 21.6 | 298 | 3.4 | Urethane | 20 | 22.3 | 596 | 4 |
| | | | | | | monomer | | | | |
| A-13 | PET30 | 80 | 21.6 | 298 | 3.4 | Urethane | 20 | 22.3 | 596 | 4 |
| | | | | | | monomer | | | | |
| A-14 | PET30 | 80 | 21.6 | 298 | 3.4 | Urethane | 20 | 22.3 | 596 | 4 |
| | | | | | | monomer | | | | |

| | Difference in | Difference in | | |
|---|---|---|---|---|
| | SP value | Mw value | | |
| Coating | between (a) and | between (a) and | Solvent (mixing ratio is mass | |
| liquid | (b) | (b) | standard) | Remarks |
| A-1 | 0.69 | 298 | Methyl acetate:MEK = 5:5 | Example |
| A-2 | 0.69 | 298 | Methyl acetate:MEK = 5:5 | Example |
| A-3 | 0.47 | 467 | Methyl acetate:MEK = 5:5 | Example |
| A-4 | — | — | Methyl acetate:MEK = 5:5 | Comparative Example |
| A-5 | 0.69 | 298 | Methyl acetate:MEK = 5:5 | Comparative Example |
| A-6 | 0.69 | 298 | Methyl acetate:MEK = 5:5 | Comparative Example |
| A-7 | 2.21 | 325 | Methyl acetate:MEK = 5:5 | Comparative Example |
| A-8 | 3.66 | 173 | Methyl acetate:MEK = 5:5 | Comparative Example |
| A-9 | 2.49 | 1351 | Methyl acetate:MEK = 5:5 | Comparative Example |
| A-10 | — | — | Methyl acetate:MEK = 5:5 | Comparative Example |
| A-11 | 1.8 | 1649 | Methyl acetate:MEK = 5:5 | Comparative Example |
| A-12 | 0.69 | 298 | MIBK | Comparative Example |
| A-13 | 0.69 | 298 | MEK | Comparative Example |
| A-14 | 0.7 | 298 | Methyl acetate:MEK = 8:2 | Example |

The respective used compounds are shown below.

Leveling Agent (SP-13):

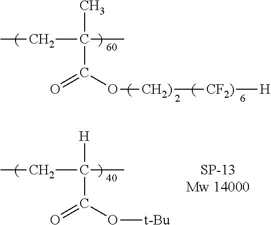

PET30: A mixture of compounds having the following structures, which is manufactured by Nippon Kayaku Co., Ltd. Its mass average molecular weight is 298, and its number of functional groups in one molecule is 3.4 (in average).

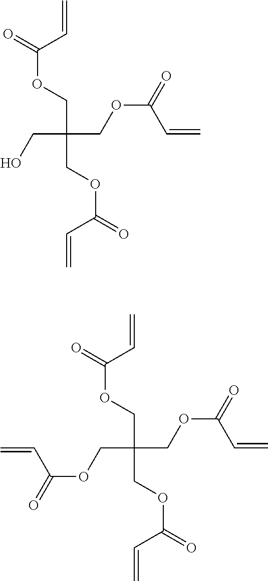

Urethane monomer: A compound having the following structure. Its mass average molecular weight is 596, and its number of functional group in one molecule is 4.

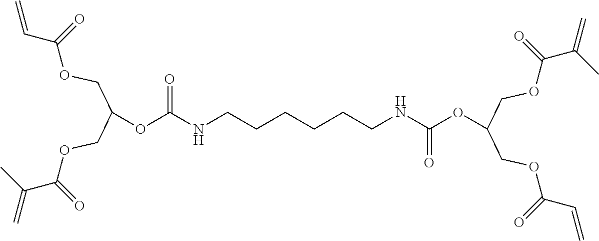

DPCA-30: A compound having the following structure, which is manufactured by Nippon Kayaku Co., Ltd. Its mass average molecular weight is 921, and its number of functional groups in one molecule is 6.

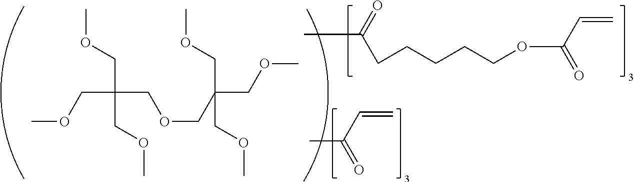

DPCA-120: A compound having the following structure, which is manufactured by Nippon Kayaku Co., Ltd. Its mass average molecular weight is 1,947, and its number of functional groups in one molecule is 6.

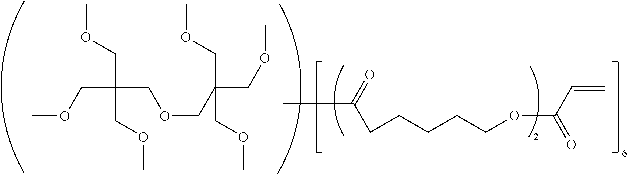

A-9300: A compound having the following structure, which is manufactured by Shin Nakamura Chemical Co., Ltd. Its mass average molecular weight is 423, and its number of functional groups in one molecule is 3.

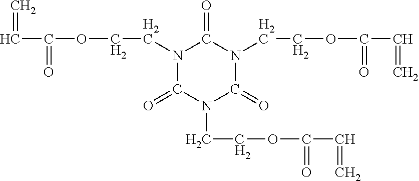

EB5129: A compound having the following structure, which is manufactured by DAICEL UCB. Its mass average molecular weight is 765, and its number of functional groups in one molecule is 6.

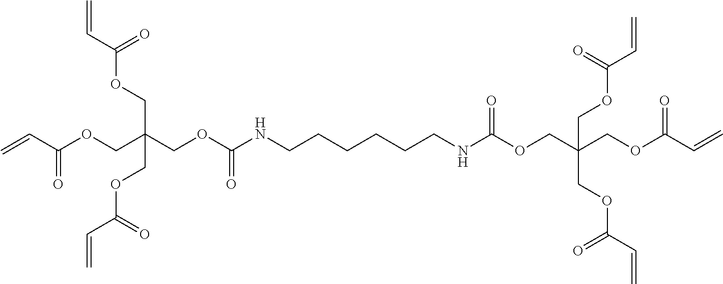

### (Preparation of Coating Liquid for Low Refractive Index Layer)

### (Synthesis of Perfluoroolefin Copolymer (1))

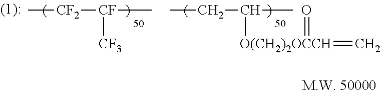

In the foregoing structural formula, the term “50/50” expresses a molar ratio.

In a stainless steel-made stirrer-equipped autoclave having an internal volume of 100 mL, 40 mL of ethyl acetate, 14.7 g of hydroxyethyl vinyl ether and 0.55 g of dilauroyl peroxide were charged, and the system was deaerated and purged with a nitrogen gas. 25 g of hexafluoropropylene (HFP) was further introduced into the autoclave, and the temperature was raised to 65° C. A pressure at a point of time when the temperature in the autoclave reached 65° C. was 0.53 MPa (5.4 kg/cm²). The reaction was continued for 8 hours while keeping the subject temperature; and at a point of time when the pressure reached 0.31 MPa (3.2 kg/cm²), heating was stopped, and the system was allowed to stand for cooling. At a point of time when the inner temperature decreased to room temperature, the unreacted monomers were expelled, the autoclave was opened, and the reaction solution was taken out. The obtained reaction solution was thrown into an excess of hexane, and a polymer precipitated by decantation for removal of the solvent was taken out. Furthermore, this polymer was dissolved in a small amount of ethyl acetate, and the solution was subjected to reprecipitation from hexane twice, thereby completely removing the residual monomers. After drying, 28 g of a polymer was obtained. Subsequently, 20 g of the subject polymer was dissolved in 100 mL of N,N-dimethylacetamide, 11.4 g of acrylic acid chloride was added dropwise under ice cooling, and the mixture was then stirred at room temperature for 10 hours. Ethyl acetate was added to the reaction solution; the mixture was washed with water; an organic layer was extracted and then concentrated; and the obtained polymer was reprecipitated from hexane to obtain 19 g of a perfluoroolefin copolymer (1). The obtained polymer had a refractive index of 1.422 and a mass average molecular weight of 50,000.

### (Preparation of Hollow Silica Particle Dispersion Liquid A)

To 500 parts of a hollow silica fine particle sol (isopropyl alcohol silica sol CS60-IPA, manufactured by Shokubai Kasei Kogyo K.K., average particle diameter: 60 nm, shell thickness: 10 nm, silica concentration: 20% by mass, refractive index of silica particle: 1.31), 30 parts by mass of acryloyloxypropyltrimethoxysilane and 1.51 parts by mass of diisopropoxyaluminum ethyl acetate were added and mixed. Thereafter, 9 parts by mass of ion exchanged water was added. The mixture was allowed to react at 60° C. for 8 hours and then cooled to room temperature. 1.8 parts by mass of acetyl acetone was added, thereby obtaining a dispersion liquid. Thereafter, the dispersion liquid was subjected to solvent replacement by means of vacuum distillation under a pressure of 30 Ton while adding cyclohexanone such that the silica content became substantially constant, and finally subjected to concentration adjustment to obtain a hollow silica particle dispersion liquid A having a solids concentration of 18.2% by mass. A residual IPA content of the thus obtained hollow silica particle dispersion liquid A was analyzed by means of gas chromatography and found to be not more than 0.5% by mass.

### (Preparation of Coating Liquid A for Low Refractive Index Layer)

21.0 parts by mass of the perfluoroolefin copolymer (1), 2.5 parts by mass of reactive silicone (X22-164C, manufactured by Shin-Etsu Chemical Co., Ltd.), 1.5 parts by mass of Irgacure 127 (manufactured by Ciba Specialty Chemicals), and 137.4 parts by mass of the hollow silica particle dispersion liquid A were added to methyl ethyl ketone to make to 1,000 parts by mass. After stirring, the resulting mixture was filtered with a polypropylene-made filter having a pore size of 5 μm, thereby preparing a coating liquid A for low refractive index layer.

### (Fabrication of Hard Coat Layer A-1)

On a cellulose triacetate film (TD80UF, manufactured by Fujifilm Corporation, refractive index: 1.48) having a thickness of 80 μm as a transparent base material, the foregoing coating liquid A-1 for hard coat layer was coated (coating amount of solids: 12.1 g/m²) using a gravure coater. After drying at 100° C., the coating layer was cured upon irradiation with ultraviolet rays at a luminance of 400 mW/cm² and a dose of 150 mJ/cm² while purging with nitrogen so as to have an atmosphere of an oxygen concentration of not more than 1.0% by volume by using an air-cooled metal halide lamp (manufactured by Eye Graphics Co., Ltd.) of 160 W/cm, thereby forming a hard coat layer A-1. There was thus fabricated a film sample No. 1.

Hard coat layers A-2 to A-13 were fabricated, respectively in the same manner by using the coating liquids A-2 to A-13 each having a coating amount of solids of 12.1 g/m². There were thus fabricated film samples Nos. 2 to 13.

### (Fabrication of Low Refractive Index Layer A)

On the hard coat layer of each of the films, the coating liquid A for low refractive index layer was coated using a gravure coater, thereby forming a low refractive index layer having a thickness of 94 nm. A drying condition was set at 60° C. for 60 seconds, and the coating layer was cured with ultraviolet rays under a condition at a luminance of 600 mW/cm² and a dose of 300 mJ/cm² while purging with nitrogen so as to have an atmosphere of an oxygen concentration of not more than 0.1% by volume by using an air-cooled metal halide lamp (manufactured by Eye Graphics Co., Ltd.) of 240 W/cm. A refractive index of the low refractive index layer was found to be 1.36.

For the measurement of the refractive index of each of the hard coat layer and the refractive index layer, the coating liquid of each of the layers was coated in a thickness of about 4 μm on a glass plate and measured for a refractive index by a multi-wavelength Abbe's refractometer DR-M2 (manufactured by Atago Co., Ltd.). A refractive index measured using a filter of “Interference Filter 546(e) nm for DR-M2, M4, RE-3523” was employed as a refractive index at a wavelength of 550 nm.

Also, the film thickness of the low refractive index layer was calculated using a reflective film thickness monitor “FE-3000” (manufactured by Otsuka Electronics Co., Ltd.). The refractive index of each of the layers at the calculation was adjusted by using the values derived by the foregoing Abbe's refractometer.

### (Evaluation of Optical Film)

Various characteristics of the optical film were evaluated by the following methods. The results are shown in Table 2.

### (1) PV Value and Interference Unevenness:

With respect to each of the samples, a sample not provided with a low refractive index layer was fabricated under the same condition, the back surface of the transparent base material (the surface on the side on which the hard coat layer was not provided) was filed with emery paper, and a PET film which had been painted over in solid black was stuck onto the subject surface. The sample was set in a reflective film thickness monitor “FE-3000” (manufactured by Otsuka Electronics Co., Ltd.), and a reflectance spectrum was determined using a three-wavelength light source. The obtained reflectance spectrum was subjected to Fourier transform, thereby determining a power spectrum relative to the optical film thickness. A peak intensity from the interface between the transparent base material and the hard coat layer was determined as a PV value from the obtained power spectrum. The measurement condition and computation condition at the time of performing the Fourier transform analysis in FE-3000 are those described below.

### (Measurement Condition)

Measurement method: Absolute reflectance

Measurement mode: Manual mode

### (Computation Condition)

Material category: Standard

Algorithm: FFT

Calculation method: Two layers and two peaks

n1d1 type: FIX refractive index: The refractive index of the hard coat layer measured by the foregoing method is designated.

n2d2 type: FIX refractive index: An average value of the refractive index of the base material and the refractive index of the hard coat layer measured by the foregoing method is designated.

The interference unevenness was evaluated on the basis of the obtained PV value according to the following criteria.

A: The PV value is 0.000 or more and not more than 0.003.

B: The PV value is more than 0.003 and not more than 0.006.

C: The PV value is more than 0.006.

### (2) Curl and F Type Curl:

### (Evaluation Method of F Type Curl)

A curl value of the film was measured according to the method of ANSI/ASC PH1.29-1985, Method A.

A sample obtained by cutting each of the fabricated films into a size of 3 mm×35 mm is firmly set vertically on a curled plate such that the sample does not protrude from a support, and then subjected to humidity control at 25° C. and a relative humidity of 60% for a humidity control time of 10 hours. After the humidity control, a memory of the curl plate to which a tip of the sample curls is read (=F type curl value). At that time, though “±” is expressed depending upon the curl direction of the film, it is meant that the larger the absolute value, the stronger the curl is.

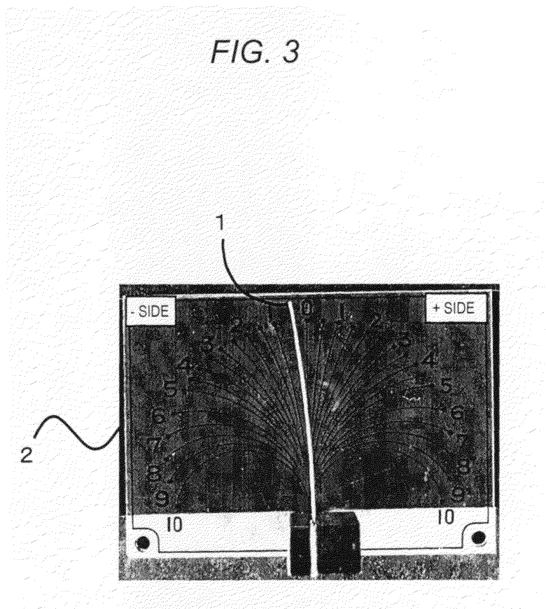

FIG. 3 is a view showing an example of measuring a curl of an optical film according to the method of ANSI/ASC PH1.28-1985, Method A. In FIG. 3, the curl of an optical film 1 is not more than 0.5 in terms of a memory of a curl plate 2.

The curl (absolute value) of each of the films was evaluated according to the following criteria.

A: Not more than 0.5

B: More than 0.5 and not more than 1.5

C: More than 1.5

### (3) Pencil Hardness:

The evaluation of pencil hardness described in JIS K5400 was carried out. After subjecting each of the film samples to humidity control at a temperature of 25° C. and a humidity of 60% RH, the resulting film sample was evaluated using a testing pencil as defined in JIS S6006 according to the following criteria.

A: 4H or more

B: 3H

C: Less than 2H

### (4) Haze:

A total haze value (%) of each of the obtained films was measured in conformity with JIS K7136. A haze meter NDH4000, manufactured by Nippon Denshoku Industries Co., Ltd. was used as an apparatus.

TABLE 2

| | Coating liquid | | | | | | Refractive | | |
|---|---|---|---|---|---|---|---|---|---|
| Optical film | for hard coat | | Interference | F type curl | | Pencil | index of hard | | |
| sample No. | layer | PV value | unevenness | (at 60%) | Curl | hardness | coat layer | Todal haze | Remarks |
| 1 | A-1 | 0.003 | A | 0.4 | A | B | 1.52 | 0.01 | Example |
| 2 | A-2 | 0.002 | A | 0.3 | A | B | 1.52 | 0.03 | Example |
| 3 | A-3 | 0.001 | A | 1.0 | B | A | 1.52 | 0.02 | Example |
| 4 | A-4 | 0.011 | C | 0.2 | A | B | 1.52 | 0.05 | Comparative |
| | | | | | | | | | Example |
| 5 | A-5 | 0.008 | C | 0.4 | A | B | 1.52 | 0.03 | Comparative |
| | | | | | | | | | Example |
| 6 | A-6 | 0.01 | C | 0.3 | A | C | 1.52 | 0.03 | Comparative |
| | | | | | | | | | Example |
| 7 | A-7 | 0.07 | C | 4.5 | C | C | 1.52 | 0.03 | Comparative |
| | | | | | | | | | Example |
| 8 | A-8 | 0.05 | C | 3.2 | C | C | 1.52 | 0.03 | Comparative |
| | | | | | | | | | Example |
| 9 | A-9 | 0.025 | C | 3.5 | C | C | 1.52 | 0.03 | Comparative |
| | | | | | | | | | Example |
| 10 | A-10 | 0.015 | C | 1.1 | B | A | 1.52 | 0.01 | Comparative |
| | | | | | | | | | Example |
| 11 | A-11 | 0.03 | C | 2.5 | C | C | 1.52 | 0.02 | Comparative |
| | | | | | | | | | Example |
| 12 | A-12 | 0.05 | C | 0.5 | A | B | 1.52 | 0.02 | Comparative |
| | | | | | | | | | Example |
| 13 | A-13 | 0.02 | C | 1.0 | B | B | 1.52 | 0.01 | Comparative |
| | | | | | | | | | Example |

As shown in Table 2, the optical film of the invention had a high hardness and was suppressed in the interference unevenness and curl.

### Example 2

Bases 1 to 3 were fabricated using dopes B-1 and B-2 shown in the following Table 3, respectively in the manner described at page 46 and 47 of the present specification.

TABLE 3

| | | | Cellulose acylate | | | | | |
|---|---|---|---|---|---|---|---|---|
| | | Film | Acetyl | | Polyester diol | | | |
| Base | | thickness | substitution | Part by | | | Hydroxyl | Part by |
| material | Dope | (μm) | degree | mass | Dibasic acid | Glycol | value | mass |
| 1 | B-1 | 40 | 2.86 | 100 | — | — | — | 0 |
| 2 | B-2 | 60 | 2.86 | 100 | Adipic acid | Ethylene | 113 | 20 |
| | | | | | (C6) | glycol (C2) | | |
| 3 | B-1 | 60 | 2.86 | 100 | — | — | — | 0 |
| | Aromatic sugar ester compound of each of | | | | Aliphatic sugar ester compound of the | | | |
| | the general formulae (I) and (II) | | | | general formula (III) | | | |
| | | | Average | | | | Average | |
| Base | Sugar | | substitution | Part by | Sugar | | substitution | Part by |
| material | structure | Substituent | degree | mass | structure | Substituent | degree | mass |
| 1 | Sucrose | Benzoyl | 5.7 | 12 | Sucrose | Acetyl/ | 2/6 | 3 |
| | | | | | | Isobutyryl | | |
| 2 | — | — | — | 0 | — | — | — | 0 |
| 3 | Sucrose | Benzoyl | 5.7 | 12 | Sucrose | Acetyl/ | 2/6 | 3 |
| | | | | | | Isobutyryl | | |

Optical films Nos. 14 to 18 were fabricated in the same manner as that in the film sample No. 1, except for using each of base material and coating liquids for hard coat layer shown in the following Table 4 and evaluated with respect to the interference unevenness and pencil hardness in the same manners as those in Table 2. Here, the base material used in the sample No. 16 is ZRD60SL (cellulose acylate film having an acetyl substitution degree of 2.86 and a film thickness of 60 μm), manufactured by Fujifilm Corporation.

TABLE 4

| Optical | | Coating | | | |
|---|---|---|---|---|---|
| film | | liquid for | | | |
| sample | Base | hard coat | Interference | Pencil | |
| No. | material | layer | unevenness | hardness | Remarks |
| 14 | 1 | A-2 | A | A | Example |
| 15 | 2 | A-14 | A | A | Example |
| 16 | ZRD60SL | A-2 | A | B | Example |
| 17 | 2 | A-2 | A | B | Example |
| 18 | 3 | A-2 | A | A | Example |

As shown in Table 4, even in the case of using a thin base material of 40 μm or 60 μm, the optical film of the invention had a high hardness, was suppressed in the interference unevenness, and revealed an excellent performance.

Incidentally, all of the optical film samples Nos. 14 to 18 had a total haze of not more than 0.1%.

Next, a coating liquid A-15 for hard coat layer was prepared in the same manner as that in the coating liquid A-2 for hard coat layer, except that the solvent used for the coating liquid A-2 for hard coat layer used in the optical film No. 14 was changed from methyl acetate/MEK of 5/5 to methyl acetate/MEK/acetone of 5/2/3. An optical film No. 19 was fabricated in the same manner as that in the optical film No. 14, except that the coating liquid A-15 for hard coat layer was used in place of the coating liquid A-2 for hard coat layer. As a result, with respect to the interference unevenness, the pencil hardness, and the curl performance, favorable results the same as those in the optical film No. 14 were revealed.

### (Saponification Treatment of Optical Film)

The foregoing sample No. 1 was subjected to the following treatment. A sodium hydroxide aqueous solution of 1.5 mol/L was prepared and kept at a temperature of 55° C. A dilute sulfuric acid aqueous solution of 0.01 mol/L was prepared and kept at a temperature of 30° C. The fabricated optical film was dipped in the foregoing sodium hydroxide aqueous solution for 2 minutes and then dipped in water, thereby thoroughly washing away the sodium hydroxide aqueous solution. Subsequently, after dipping in the foregoing dilute sulfuric acid aqueous solution for 20 seconds, the resultant was dipped in water, thereby thoroughly washing away the dilute sulfuric acid aqueous solution. Finally, the sample was thoroughly dried at 120° C.

There was thus fabricated an optical film having been subjected to a saponification treatment.

### (Fabrication of Polarizing Plate)

An 80 μm-thick triacetyl cellulose film (TAC-TD80U, manufactured by Fujifilm Corporation) which had been prepared by dipping in an NaOH aqueous solution of 1.5 mol/L at 55° C. for 2 minutes, followed by neutralization and washing with water, and the saponification treated optical film were bonded onto the both surfaces of a polarizer fabricated by adsorbing iodine on polyvinyl alcohol and stretching and protected, thereby fabricating a polarizing plate.

### (Fabrication of Circular Polarizing Plate)

A λ/4 plate was stuck onto the surface of the polarizing plate sample on the opposite side to the low refractive index layer with an adhesive, thereby fabricating a circular polarizing plate, and the circular polarizing plate was stuck onto the surface of an organic EL display with an adhesive such that the low refractive index layer was located outside. As a result, a favorable display performance was obtained without causing scuffing or color unevenness.

The foregoing circular polarizing plate was used as a polarizing plate on the surface of each of a reflection type liquid crystal display and a semi-transmission type liquid crystal display such that the low refractive index layer was located outside. As a result, a favorable display performance was obtained without causing scuffing or color unevenness.

Incidentally, even when the foregoing triacetyl cellulose film was replaced by a film having a thickness of 60 μm (TAC-TD60U, manufactured by Fujifilm Corporation), a favorable display performance was similarly obtained without causing scuffing or color unevenness.

The entire disclosure of each and every foreign patent application from which the benefit of foreign priority has been claimed in the present application is incorporated herein by reference, as if fully set forth.

What is claimed is:

1. An optical film comprising a transparent base material having thereon a hard coat layer formed of a hard coat layer forming composition containing the following (a), (b), (c) and (d),
wherein
a refractive index of the hard coat layer is 1.45 or more and not more than 1.55; and
in the hard coat layer forming composition, a content of the component (a) is a content of the component (b) or more:
(a) a compound having three or more functional groups in one molecule thereof and having an SP value SPₐ according to the Hoy method satisfying a relation of 19<SPₐ<25 and a mass average molecular weight Mwₐ satisfying a relation of 40<Mwₐ<1,600;
(b) a urethane compound having three or more functional groups in one molecule thereof and having an SP value SP_{b} according to the Hoy method satisfying a relation of 19<SP_{b}<25 and a mass average molecular weight Mw_{b} satisfying a relation of 150≦|Mw_{b}−Mwₐ|≦500;
(c) a solvent having dissolving ability against the transparent base material; and
(d) a solvent having swelling ability against the transparent base material.

2. The optical film according to claim 1, wherein the solvent (c) is at least one member of methyl acetate and acetone.

3. The optical film according to claim 1, wherein the solvent (d) is methyl ethyl ketone.

4. The optical film according to claim 1, wherein a content of the solvent (c) is a content of the solvent (d) or more.

5. The optical film according to claim 1, wherein the SP value SPₐ of the compound (a) satisfies a relation of 21<SPₐ<25.

6. The optical film according to claim 1, wherein the transparent base material is a cellulose acylate film.

7. The optical film according to claim 1, wherein a haze of the hard coat layer is not more than 1%.

8. An optical film comprising a transparent base material having thereon a hard coat layer having a haze of not more than 1.0%, wherein a peak intensity PV value obtained by subjecting a reflectance spectrum by an optical interference method to a Fourier transform is from 0.000 to 0.006.

9. The optical film according to claim 8, wherein the PV value is from 0.000 to 0.003.

10. A polarizing plate comprising the optical film according to claim 1 as a protective film for polarizing plate.

11. An image display device comprising the optical film according to claim 1.

12. A method for manufacturing the optical film according to claim 1, which comprises a step of coating the hard coat layer forming composition on the transparent base material and curing it to form a hard coat layer.
